(19) United States
(12) Patent Application Publication
(10) Pub. No.: US 2025/0278851 A1
(43) Pub. Date: Sep. 4, 2025

(54) VR GEOFENCING FOR PLAY SPACE AND VR APPLICATION ENABLEMENT AND DISABLEMENT

(71) Applicant: Adeia Guides Inc., San Jose, CA (US)

(72) Inventors: Christopher Phillips, Hartwell, GA (US); Charles Dasher, Lawrenceville, GA (US); Reda Harb, Tampa, FL (US)

(21) Appl. No.: 18/592,303

(22) Filed: Feb. 29, 2024

(51) Int. Cl. G06T 7/70; G06F 9/54; G06T 11/00; H04L 67/52

(52) U.S. Cl. CPC G06T 7/70; G06F 9/54; G06T 11/00; H04L 67/52

(57) ABSTRACT

System and method for defining space for use of extended reality (XR) devices, including augmented reality (AR) and virtual reality (VR) devices, and, in particular, to defining permitted areas and prohibited areas of use for one or more XR devices in a physical space, and for providing visual indications directing a user to a defined permitted area.

### BACKGROUND

The present disclosure relates to defining space for use of extended reality (XR) devices, including augmented reality (AR) and virtual reality (VR) devices, and, in particular, to defining permitted areas and prohibited areas of use for one or more XR devices in a physical space, and for providing visual indications directing a user to a defined permitted area.

### SUMMARY

A technological problem that arises from the use of XR applications and, more particularly, VR applications, is the necessity for sufficient physical space within which to operate an XR device. If a given physical space is too limiting, accidental collision of an XR user wearing an XR device, such as a head mounted display (HMD), may occur. For example, when using XR equipment, people are completely immersed in the virtual world simulated by the XR equipment and have the physical sensation of being present in that virtual world. As a result, an XR device user may have no awareness of the physical environment outside of the user's XR headset and collide with nearby objects or people, causing injury or damage to themselves, others, nearby property, or the XR equipment.

In one approach, boundaries within a physical space in which XR device use is permitted are defined as a permitted area, and boundaries within a physical space in which XR device use is prohibited are defined as a prohibited area. The borders of permitted areas and prohibited areas can be communicated to the XR device, which may be configured to display virtual boundaries (“guardians”) to a user via an HMD by indicating virtual boundaries having fixed or relatively fixed locations in the physical space. For example, when an XR device user steps outside of a permitted area, a warning sign may be displayed and the XR function can be disabled. Further, a “passthrough” mode may be activated, which enables the user to see the physical area through the XR device, e.g., via a camera image, without having to remove the XR device from their head. As a result, the XR user suddenly gains awareness of their position and orientation in physical space, thus preventing unwanted collisions, damage, or injury to the user or to others in the nearby vicinity. Such virtual boundaries can be previously demarcated, e.g., by a property owner, and transmitted to any XR device entering a particular physical space.

In one approach, the area of XR device use is a shared area, such as a gym. In this example, a gym owner may designate areas within the gym space as permitted areas, e.g., an open room designated for XR usage, and areas as prohibited areas, e.g., a weight lifting space housing heavy equipment that present potential for dangerous collisions to XR device users. In some embodiments, permitted and prohibited areas are designated indefinitely, while in further embodiments, the permitted and prohibited designations are schedule-based and change according to a predetermined gym schedule. For example, an open room can be designated as a permitted area when an XR workout session is scheduled, and designated as a prohibited area when a non-XR workout class is scheduled.

In a further approach, the area of XR device use is a non-shared area, such as a living room in a private home. In this example, areas within the home can be permanently designated as prohibited areas, such as a kitchen or bathroom, while other areas can be permanently designated as permitted areas, such as a playroom. Additional areas can be designated as either a permitted area or a prohibited area based on a time schedule, e.g., a living room can be designated as a permitted area only during certain evening hours. For example, a parent can set time limits of permitted XR device use after a time that homework is expected to be completed by a child. Additionally, a permitted area can be subdivided to have permanent prohibited areas for safety reasons, e.g., a couch or end table within the living room may be permanently off limits even during the time periods of permitted use.

In one approach, the designated areas of permitted use are assigned to individual XR devices, and may be adjusted based on the number of XR devices that are simultaneously present within a physical space. Continuing with the gym example discussed above, when a first XR device is present within a permitted area, the entire space is designated as permitted for the first XR device. Upon detection of a second XR device entering the permitted area, the designated permitted area is divided into two separate permitted areas, where the first XR device is permitted only in a first section of the permitted area and the second XR device is permitted in a non-overlapping second section of the permitted area. Thus, the designated permitted area can be a persistent designated permitted area, but one that is dynamic and automatically redefined in real time in response to detection of a second XR device in the physical space or in response to the termination of the session/deactivation of the second XR device sharing the same physical space, resulting in efficient and dynamic allocation of the shared physical space. For example, if a second user enters the physical area while a first user is already engaged in an XR session, safe areas for each of the first and second users may be automatically allocated dynamically and in a fair manner to maximize the usable XR permitted area for each XR device. Further still, one or more disclosed techniques enable a user to engage in XR activity easily and reliably with the confidence that, by remaining within their designated permitted section, they will avoid unexpected collisions and injuries.

According to an embodiment, when two or more XR devices simultaneously share the same physical space, the permitted areas demarcated for each device are combined and a reconfigured first permitted area and a reconfigured second permitted area are allocated automatically using a virtual partition as a boundary between them. The virtual partition may be visible on each XR device and may include a buffer zone to prevent collision due to movement of the arms or legs of a wearer of the XR device. A collision warning may be provided when the XR device approaches the virtual partition and/or when the XR device passes the virtual partition. When an XR device passes into the safe area of the other XR device, passthrough vision on the XR device may be enabled, warnings may be provided and/or a virtual guide or directional indicators may be displayed by the XR device to guide the user of the XR device back to a permitted area allocated to the wayward XR device.

When further dividing up a permitted area, the virtual partition may be drawn so as to allocate equal, or approximately equal, permitted sub-areas for each of the XR devices. In an embodiment, the permitted areas may be allocated depending on the activity level typically generated by the application active for the XR device. For example, an XR device running a virtual workout application that often calls for vigorous rapid movement may be allocated a permitted area greater in size than one that is running an application that usually calls for more sedate activity. The user profile of the wearer of the XR device may also be consulted to determine the activity intensity level, the area of movement, and/or frequency of vigorous movement associated with the application running on the XR device. The reconfigured permitted areas may be calculated to each provide as large a usable area as possible. The shape or configuration of the usable area may be determined based on the application and may maximize the ratio of the area of the permitted area to the perimeter of the permitted area. For example, a permitted area that is nearly circular or oval may provide more room for movement than a narrow, elongated permitted area.

The reconfigured permitted areas and the virtual partition for two or more XR devices sharing a physical space may be generated by an off-site server, for example, a SLAM (Simultaneous Location And Mapping) network edge service, and may use Wi-Fi-based localization of the XR devices. For example, relevant maps of the physical space may be retrieved over a remote internet connection, and localization may be performed by a local, edge, or remote SLAM service, with or without an internet connection. In an embodiment, a server or a connected cloud service is controlled by a property owner, where the permitted areas are designated at a first time and are accessed by an XR device at a second time. For example, a gym owner may designate a weight room as a permanently prohibited area and a workout room as a permitted area during designated hours. Within the timeframe of the designated hours for the permitted area, only certain XR devices may be granted permission to function within the space, e.g., XR devices associated with users having a current gym membership. In an embodiment, multiple conditions for permitted area use are required to be fulfilled to enable XR device usage. As an illustrative example, an XR device may be configured to function in a workout room of a gym only when all predetermined conditions are met, such as a) a profile associated with the XR device indicates an active gym member status, b) a permitted area is currently available for use with XR devices, c) the profile is registered for a class that is currently being held in the space, and d) only applications assigned a “fitness” type are permitted for execution on the XR device. In an embodiment, additional granular controls are available, e.g., permission of only yoga focused fitness applications, or a specific yoga application, for use within a space designated for a yoga class use within the permitted area at a predetermined time.

Thus, a technological solution provided according to an aspect of the disclosure is generating the demarcations of permitted areas and prohibited areas of XR device use within a physical space, determining if an XR device is located within a permitted area or a prohibited area, and transmitting a signal to the XR device indicating the permitted or the prohibited use. The demarcations of the permitted areas and prohibited areas may be location based only, or location based and time based. Additionally, the size and shape of the permitted areas and prohibited areas can be dynamically adjusted based on the number of detected XR devices within the physical space.

A method, system, non-transitory computer-readable medium, and means for implementing the method are discussed for determining whether an XR device is located within a permitted area or a prohibited area. The method may include: accessing first location information of a first specified area, wherein the first specified area is an area of physical space in which use of an extended reality (XR) device is permitted, accessing second location information of a second specified area, wherein the second specified area is an area of physical space in which use of the XR device is prohibited, determining whether an XR device is located within the first specified area, and in response to determining that the XR device is located within the first specified area, transmitting a first signal to the XR device indicating that a function of the XR device is permitted, and in response to determining, at a later time, that the XR device is located within the second specified area, transmitting a second signal to the XR device indicating a function of the XR device is prohibited.

In an embodiment, determining whether the XR device is located within the permitted area or within the prohibited area is based on geolocation information received from the XR device. In a further embodiment, the XR device location is determined based on image analysis using image information received from the XR device.

In an embodiment, the function of the XR device that is permitted within the permitted area or prohibited within the prohibited area is the execution of an application on the XR device, and is based on a determined type of application. Further, determining that the execution of the application is permitted or prohibited may be based on time restrictions associated with the XR device or with the physical space.

In response to the XR device entering a prohibited area, the system may generate a display at the XR device warning that the XR device is in a prohibited area, and transmit a signal requesting activation of a passthrough display. For example, a display at the XR device may generate a warning that the XR device is in a prohibited area, and in response to the XR device entering the prohibited area, the display of the XR device is shown to indicate a path to a permitted area from the location of the XR device in the prohibited area.

The control circuitry for this method may be provided in a network edge service and the locations of the first permitted area and the second permitted area, or the coordinates of their boundaries, may be stored in the network edge service. In an embodiment, the control circuitry may be part of a SLAM network edge service and the first and second XR devices may be SLAM-enabled devices controlled by the SLAM-network edge service.

Also contemplated is a method that includes: storing a first permitted area of a first XR device in a physical space; detecting a second XR device active in the physical space; in response to the detecting, dynamically updating, by control circuitry, the first permitted area of the first XR device and generating a second permitted area for the second XR device outside of the first permitted area; and transmitting a first signal to the first XR device indicating the revised first permitted area for exclusive permitted use of the first XR device and transmitting a second signal to the second XR device indicating the second permitted area for exclusive permitted use of the second XR device.

Such a method may also include determining that one of the first XR device or the second XR device is deactivated in the physical space and that another of the first XR device or the second XR device is active in the physical space, and dynamically updating the permitted area of the other of the first XR device for exclusive permitted use of the other XR device by combining the revised first permitted area with the second permitted area. For example, the system may detect deactivation when the XR device is turned off, when the XR application is no longer running on the XR device, when the XR device is out of the physical space, e.g., is more than a threshold distance away from its permitted area or more than a threshold distance away from all permitted areas of the physical space, or when the XR device has not moved for a threshold period of time, for example, 30 seconds, two minutes, or 5 minutes. Such a threshold distance away from the permitted area or from all permitted areas of the physical space may be, e.g., 5 meters, 10 meters, or 30 meters.

Other aspects and features of the present disclosure will become apparent to those ordinarily skilled in the art upon review of the following description of specific embodiments in conjunction with the accompanying figures.

### BRIEF DESCRIPTION OF THE DRAWINGS

The present disclosure, in accordance with one or more various embodiments, is described in detail with reference to the following Figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 illustrates an example of a home layout with defined permitted areas and prohibited areas, in accordance with some embodiments of the disclosure.

FIGS. 2-3 illustrate examples of a gym layout with defined permitted areas and prohibited areas, in accordance with some embodiments of the disclosure.

FIG. 4 is a method of detecting an VR device and transmitting a signal indicating permitted or prohibited use areas, in accordance with some embodiments of the disclosure.

FIGS. 5A-5C illustrate an example of an irregular-shaped defined area for VR device usage with a grid overlay, in accordance with some embodiments of the disclosure.

FIG. 6 illustrates an example of an VR device with peripheral devices, in accordance with some embodiments of the disclosure.

FIG. 7A-7B are network diagrams illustrating a VR service provider system communicating with a property owner devices and user devices, in accordance with some embodiments of the disclosure.

FIGS. 8A-E are flowcharts of a method for creating a geofenced area for VR device usage, and for defining and updating permitted and prohibited areas, in accordance with some embodiments of the disclosure.

FIG. 9 is a flowchart of a method for automatically generating play space areas, in accordance with some embodiments of the disclosure.

FIG. 10 is a flowchart of a method for claiming property ownership of a property for use with an VR system, in accordance with some embodiments of the disclosure.

FIGS. 11A-11C are flowcharts of a method for enforcing geolocation and geofencing policies for VR users, in accordance with some embodiments of the disclosure.

FIGS. 12A-12B are flowcharts of a method for determining and saving grid corners in irregular play spaces, in accordance with some embodiments of the disclosure.

FIG. 13 is a flowchart of a method for generating an outlying polygon, in accordance with some embodiments of the disclosure.

FIG. 14 is a flowchart of a method for determining and saving intersection boundary coordinates of irregular polygon, in accordance with some embodiments of the disclosure.

FIG. 15 is a flowchart of a method for generating poly line segment coordinates, in accordance with some embodiments of the disclosure.

FIGS. 16A-16B are flowcharts of a method for generating new play spaces coordinate lists, in accordance with some embodiments of the disclosure.

FIG. 17 is an illustrative example of a visual display of an XR device with a visual indicator directing toward a permitted area, in accordance with some embodiments of the disclosure.

FIG. 18 illustrates examples views of an XR device displaying prohibited areas, in accordance with some embodiments of the disclosure.

FIG. 19 illustrates an example of a sequence diagram defining geolocation policies for XR device usage, in accordance with some embodiments of the disclosure.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood that the embodiments and examples described herein may be practiced without these specific details. In other instances, well-known methods, procedures and components, including software, firmware and hardware components, have not been described in detail so as not to obscure the embodiments described herein. Also, the description is not to be considered as limiting the scope of the embodiments described herein.

As used herein, an “XR device” refers to a device providing virtual reality (VR), mixed or merged reality (MR), or augmented reality (AR) functionality (e.g., wherein virtual objects or graphic overlays are provided in addition to real-world objects or environments visible via the device). An XR device may take the form of glasses or a headset in some instances (e.g., a head-mounted display or HMD). An XR device may include a stereoscopic head mounted display (HMD), which may include eye-tracking sensors to control the display, one or more game controllers used as input/output devices for controlling an XR application, and other XR application-specific equipment, such as movement sensitive rackets and paddles, laser pointers and laser guns, and the like. While some references are made to a VR device or devices, appreciate that some or all of the described techniques may be implemented with respect to any suitable XR device (e.g., an XR device that provides an MR or AR scene that is partially or wholly populated by virtual objects). For example, some or all of a real-world environment may be visible via XR devices of multiple users, and the users may generate reconfigured permitted areas and a virtual partition for their XR devices utilizing the techniques discussed herein.

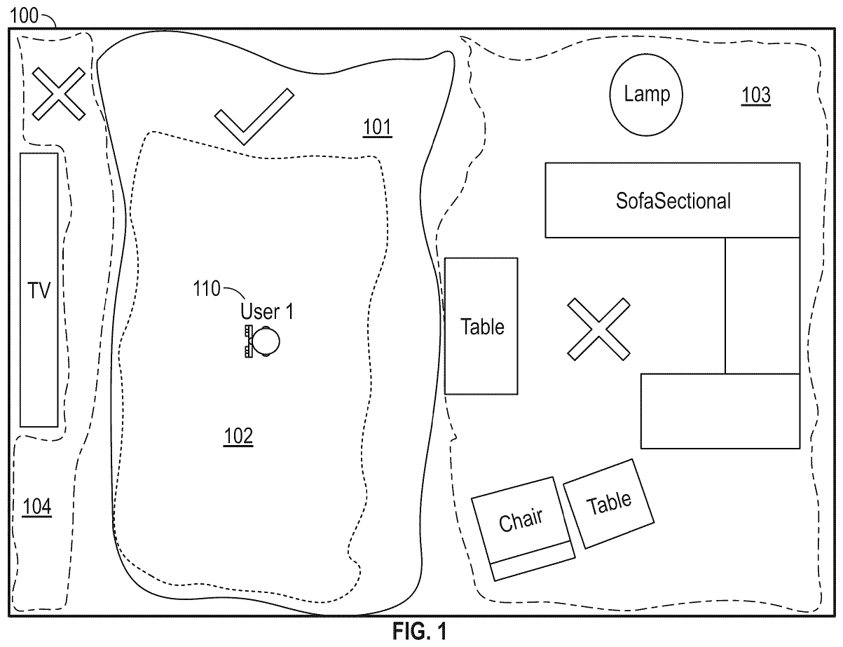

FIG. 1 illustrates an example of a home layout with defined permitted areas and prohibited areas, in accordance with some embodiments of the disclosure. As will be discussed further below, the policies defining permitted areas and prohibited areas can be established beforehand, e.g., by a property owner or XR system administrator. In an embodiment, one or more user defined spaces may be created within the confines of the permitted areas. The policies can be flexible, e.g., change depending on which XR device is connected, or which user account is associated with the XR device, on which programs or types of programs are executed or attempted to be executed on the XR device, and the like. Further, the policies can be inflexible, e.g., a particular area can be designated as a prohibited area with no variable that would change its status to a permitted area. The formation, storage, and retrieval of these polices are further discussed below.

A plan view of a living room 100 is shown. The living room is divided into subsections based on a location demarcation that includes geofenced permitted areas 101 where use of an XR device is permitted, and geofenced prohibited areas 103 and 104, where use of an XR device is prohibited. In an embodiment, the permitted area 101 is designated to allow for the creation of one or more user defined spaces within the confines of the permitted area 101. As shown, a user defined space 102 is created within the permitted area 101, where use of an XR device associated with User 1 is permitted within the user defined space 102. The prohibited areas 103 and 104 may include areas where obstructive items, such as a table, a chair, a couch, a television set, and the like are located. Additionally, no user defined spaces may be created within a prohibited area. In an embodiment, the permitted area 101 or the user defined space 102 is demarcated by a virtual boundary that is visible via the XR device. The XR device can be configured to provide a warning when approached the boundary of the user defined space 102.

In some embodiments, multiple XR devices are permitted for use within the permitted area 101, wherein each XR device is assigned a separated sub-area. The sub-areas may be user defined spaces, such as space 102, automatically created sub-areas, e.g., using area division techniques discussed further herein, or both. The XR applications executed and displayed by the HMD of each of the XR devices of multiple users may be different XR applications or the same XR application. For example, the XR device users may be playing entirely unrelated XR (e.g., VR) games or they may be playing the same game against or together with each other.

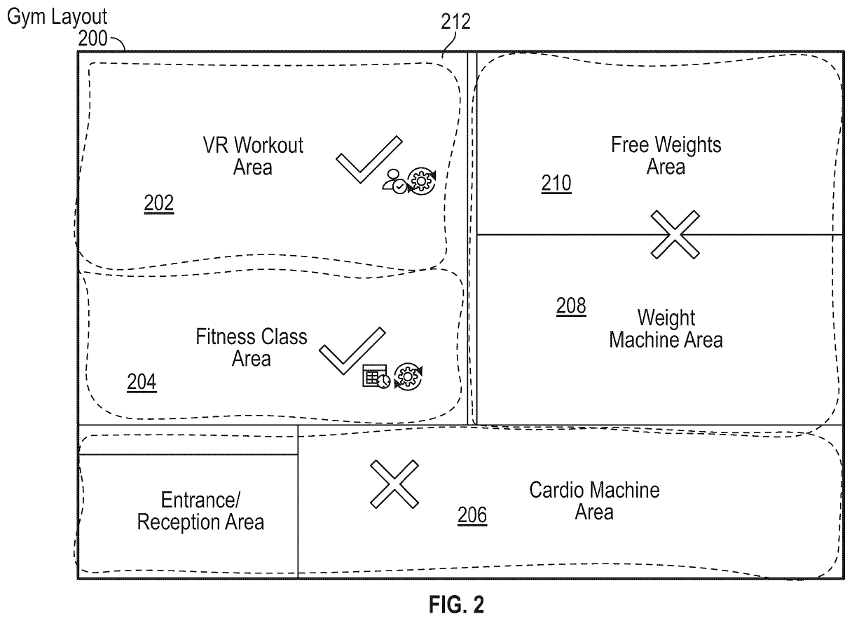

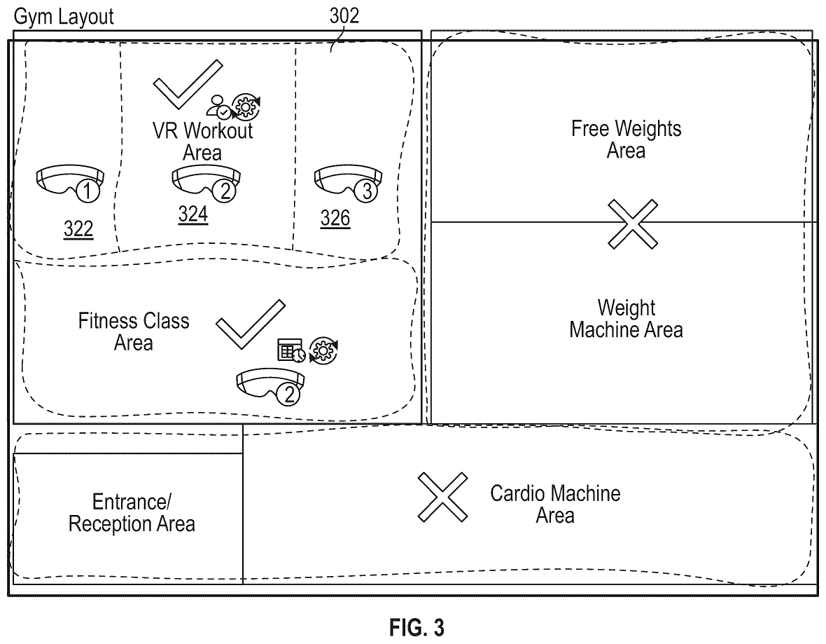

FIGS. 2-3 illustrate examples of a gym layout 200 with defined permitted areas and prohibited areas for XR device use, in accordance with some embodiments of the disclosure. The illustrative gym layout 200 includes a number of rooms and subdivisions within one or more of the rooms. In the example shown in FIG. 2, a cardio machine area 206 is designated as a prohibited area, and therefore is geofenced with a policy to limit, prevent, or prohibit XR device usage. Additional rooms for weight machines 208 and free weights 210 are designated as prohibited areas where no XR device usage is permitted. In each of the prohibited areas, when an XR device is initiated and identified, e.g., via a device-network handshake, via a location or device ID determination, and the like, a warning message is displayed via the XR device indicating that the present area does not allow for XR device usage. Additionally, any attempt at creating a user defined space for XR device use is prohibited, preventing any XR device use within the area.

In an embodiment, a single room 212 is subdivided into two areas, a VR workout area 202 and a fitness class area 204. The VR workout area is designated as a permitted area for VR devices, but may be further defined by designating some XR devices as allowed devices and others as prohibited devices. For example, the VR workout area may only allow XR device use for devices associated with users who are tagged as current gym members. Additionally, the VR workout area 202 may only allow permitted users to use the area for specific programs, e.g., for executing fitness type XR programs as opposed to gaming XR programs, or for use with a particular fitness XR program. Further, the VR workout area may only permit use of the XR devices of gym members to execute fitness programs during hours in which the gym is open, and prohibit their use after hours. In some embodiments, rather than allowing each user to define their own space, areas may be automatically allocated to each user within the permitted area. If there is not enough available space to allocate to a new user, a warning message may be displayed via the new user's XR device indicating that the present area cannot accommodate additional XR device usage at the present time. In some embodiments, if the volume of space allocated to each user exceeds a minimum safe volume of space, space may be reallocated for a new user by shrinking the allocated areas for each current user by an amount that, aggregated together, comprises at least the minimum safe volume of space for the new user. A warning message may be displayed to each other user, via their respective XR devices, indicating that their allocated space has been reduced.

Fitness class area 204 is designated as a permitted area for specific time periods within a predetermined schedule. For example, at a first block of time that is designated for an aerobic class, the area 204 is designated as a prohibited area for all XR devices, and at a second block of time, the area 204 is designated as a permitted area for a select subset of users, e.g., current gym members who have been assigned a “VR fitness user” status, or users registered for a fitness class scheduled to take place in area 204 at the present time. In some embodiments, space is automatically allocated to each user as described above.

FIG. 3 shows a similar layout of the gym with the VR workout area 302 further subdivided into additional areas. As an illustrative example, a first subdivision 322 is configured for use with XR device type 1, but prohibits use with XR devices type 2 and 3. Similarly, a second subdivision 324 is configured for use with XR device type 2, but prohibits use with XR devices type 1 and 3, and a third subdivision 326 is configured for use with XR device type 3, but prohibits use with XR devices type 1 and 2. Device type can be a device associated with a specific manufacturer or company, or associated with a particular category of user.

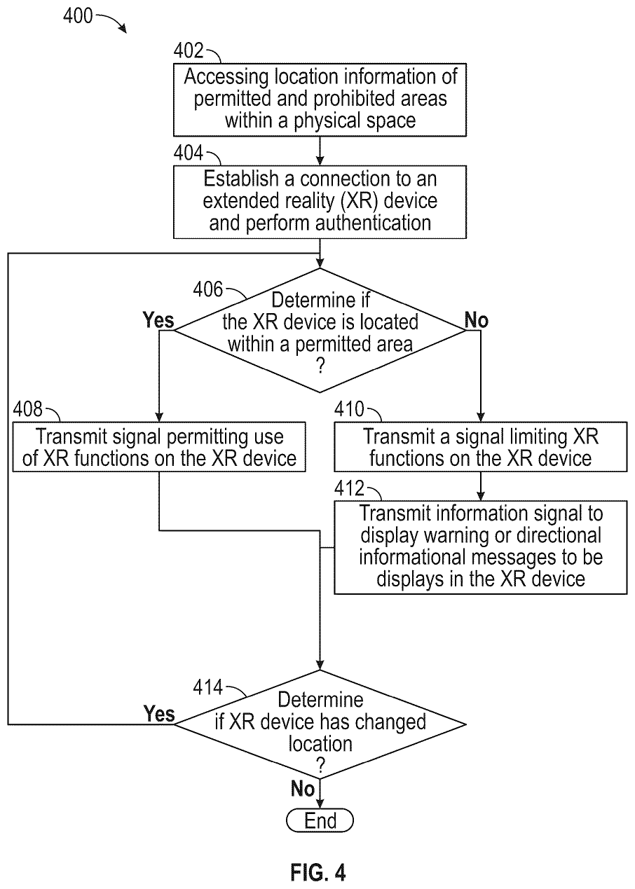

FIG. 4 is a method 400 of detecting an XR device and transmitting a signal indicating permitted or prohibited use areas, in accordance with some embodiments of the disclosure. The method 400 begins at step 402 where location information of permitted and prohibited areas of XR device use within a physical space is accessed, e.g., from a storage server of a property owner, an XR cloud service, or an XR device management service connected to a server via a network connection. At 404 a connection is established with an XR device and an authentication function is performed, e.g., using user credentials. The connection and authentication may be performed by a local or cloud-based XR device management system, e.g., via a wireless or cellular connection to the XR device. The XR device may be authenticated using biometric data, such as a facial, retinal or finger scan obtained from the user. The authentication function may access a user account database to perform the authentication. The same XR device may be used by more than one user. The system may automatically authenticate an XR device that the system recognizes as previously registered and associated with an account, or may do so only if the XR device is detected to be in the same physical space, or using the same Wi-Fi network, as the account previously registered.

In an embodiment, the permitted and prohibited areas are areas previously designated by a property owner or an XR system administrator, as further discussed herein, and saved to a server accessible to the XR device via a network connection. At 406, is it determined if the XR device is located within a permitted area. If so, the method continues at 408 where a signal permitting use of VR function, such as the execution and use of fitness XR applications on the XR device, is transmitted to the XR device. The method continues at 414.

If it is determined that the XR device is not located within a permitted area, at 410 a signal limiting XR functions of the XR device is transmitted. Limiting XR functions includes precluding any use of the XR device; permitting certain use, e.g., permitting use of educational XR applications and prohibiting user of gaming XR application; or allowing partial use of XR functions according to a predetermined schedule. An example of such a schedule includes permitting use of a fitness XR application for a device associated with a user identified as a gym member only during a period designated for XR fitness use. At 412, an information signal is transmitted to the XR device. The information signal may include a warning, such at a textual message stating “XR device use is prohibited in this space,” and/or directional indicators such as arrows highlighting a path toward a permitted area. The method continues at 414.

At 414, it is determined if the XR device has changed location. In an embodiment, the determination of location change is performed at a predetermined frequency, e.g., every 30 seconds. In a further embodiment, the determination is performed in real time, e.g., based on a GPS location signal. If no location change is detected, the method ends. If a location change has been detected, the method returns to step 406.

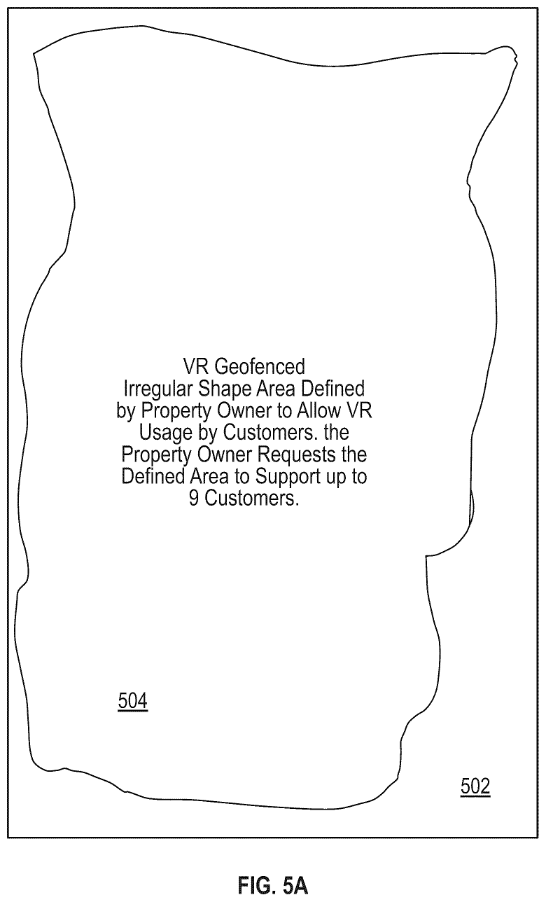

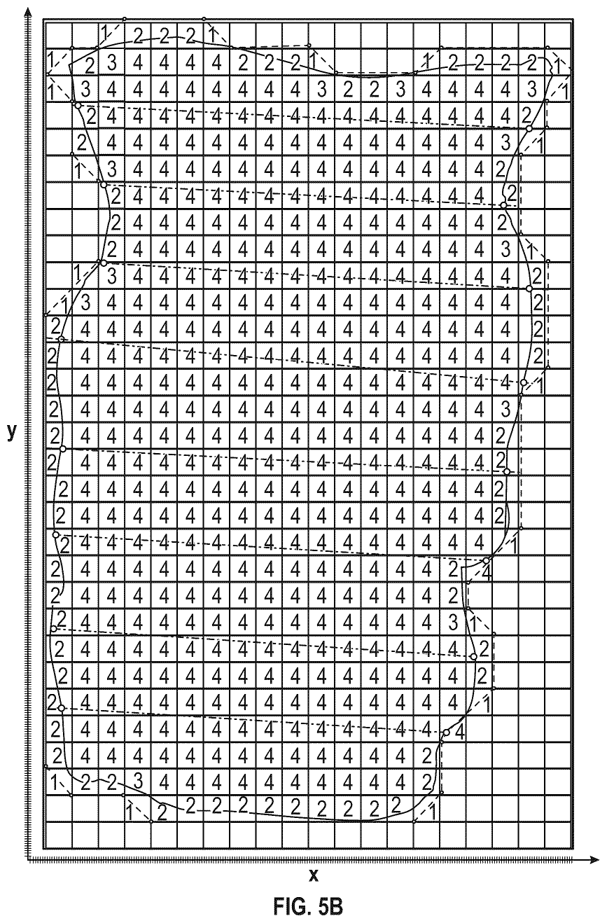

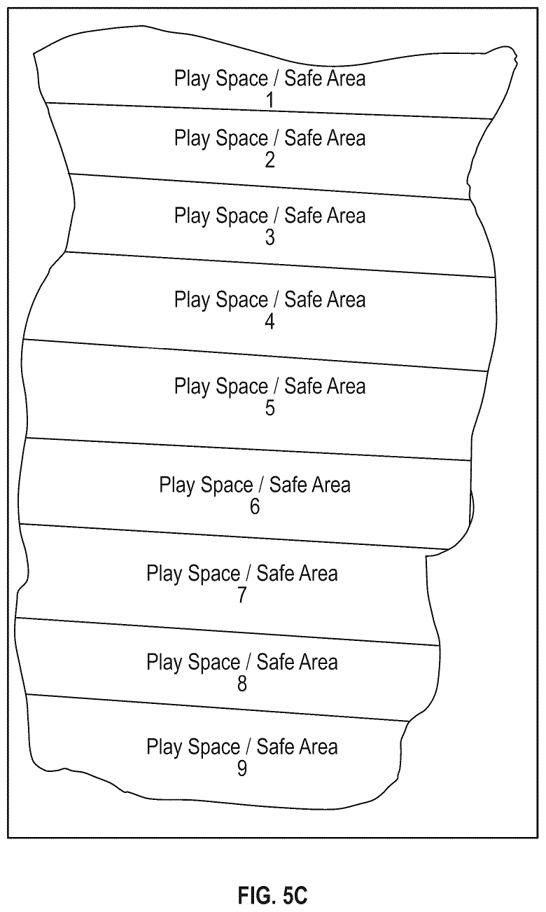

FIGS. 5A-5C illustrates an example of an irregular-shaped defined area for XR device usage with a grid overlay, in accordance with some embodiments of the disclosure. FIG. 5A shows a rectangular-shaped room 502, where an irregular-shaped area 504 has been designated as a permitted area for XR device use, similar to the permitted areas shown in FIGS. 1-3. In an illustrative embodiment, a property owner, or an XR system administrator, designates an irregular shape to avoid obstacles, provide sufficient buffer space from walls or other obstacles, contain the permitted area within a desirable location within the physical space, and the like.

In FIG. 5B, an orderly grid is overlaid on a projection of the entire rectangular space, where a number is assigned to each cell of the grid that overlaps with the irregular-shaped permitted area. In an embodiment, the system assigns a number to each square of the grid: the system assigns a 4 to a square of the grid if the entire square is inside the designated permitted area, a 3 is assigned to a square if three corners of the square are inside the permitted area, a 2 is assigned to a square if two corners of the square are inside the permitted area, and a 1 is assigned to a square if only one corner of the square is inside the permitted area. Next, the system draws a polygon with straight lines connecting the corners according to the number assigned to each square of the grid. Thus, if a square of the grid was assigned a 4 then the boundary of the polygon is drawn to include the entire square. If a square of the grid was assigned a 3, then the boundary of the polygon is drawn to include all but one corner of the square. If a square of the grid was assigned a 2, then the boundary of the polygon is drawn to include two corners of the square. If a square of the grid was assigned a 1, then the boundary of the polygon is drawn to include only 1 corner of the square. The resolution of the orderly grid may vary or may be arbitrarily assigned. A grid having finer resolution, i.e., where the size of the squares within the grid are small relative to the overall space, will conform more closely to the shape of the irregular polygon, resulting in a more precise division of the irregular shape into multiple equally sized permitted play spaces. Additionally, a play space may be assigned a particular weight, e.g., a weight of 2, resulting in the combination of two adjacent play spaces into one larger play space for a particular user.

As further shown in FIG. 5B, the irregular-shaped permitted area is subdivided into nine subareas that may be assigned to nine unique XR devices. The system is configured to create a grid over the spatially mapped area, where the size of the squares of the grid may be related to a set length scale, e.g., each square represents a specific area in square inches or square feet. Once the grid is created, the system calculates the number of grid squares that are located within the geofenced defined irregular-shaped permitted area. An outlying polygon is then created, e.g., using the number of corners of exterior squares that are present within in the grid. The outlying polygon is divided into n number of equally sized areas using a dividing algorithm, e.g., by drawing dividing lines over the grid to separate the equally sized areas. An intersection of the dividing lines of the equally sized areas with the outer border of the irregular shape is determined. Each of the outer borders of the irregular shape that intersect the dividing lines of the equally sized areas are used to generate the play areas. All inner dividing lines of the equally sized areas are used to define play space areas. For an equally sized area positioned at an edge of the irregular-shaped permitted area, only one relevant dividing line of that area's borders is used to define the new play space areas, with the outer border of the irregular shape providing the corresponding border.

FIG. 5C shows a resulting divided irregular-shaped permitted areas with nine separate assigned subareas, Play Spaces/Safe Areas 1-9, which can be assigned to nine separate XR devices. In a further embodiment, a buffer zone is introduced between each of the subareas. The boundaries of the buffer zones may be located by drawing parallel lines on either side of the partitions such that each of the parallel lines is equidistant from the partition. The partition may then be replaced by the buffer zone. For example, the buffer zone may be drawn so that it is 1.5-3 meters in width, or 2 meters in width, and may extend to completely separate each of the subareas.

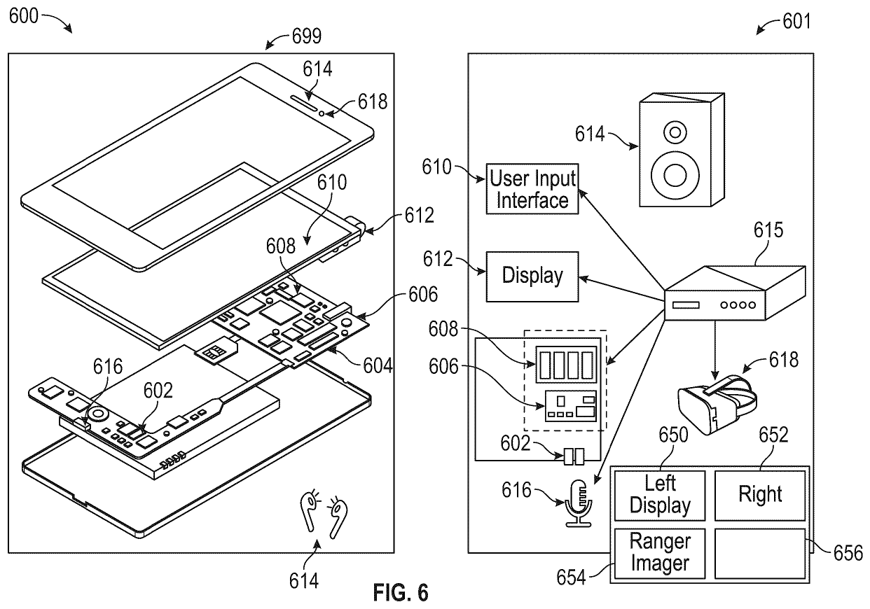

FIG. 6 illustrates an example of an XR device 618 with peripheral devices, such as a computing device, in accordance with some embodiments of the disclosure. The computer device may also be a network edge service devices, such as a server, including components used for supporting permitted area management. A circuit board may include control circuitry, processing circuitry, and storage (e.g., RAM, ROM, hard disk, removable disk, etc.). In some embodiments, the circuit board may include an input/output path for communicating with the HMD of the XR device and with a remote device, for example, with the network edge service. Each device 600/601 may receive content and data via input/output (I/O) path 602 that may comprise I/O circuitry (e.g., network card, or wireless transceiver). I/O path 602 may communicate over a local area network (LAN) or wide area network (WAN), for example, via Wi-Fi, Bluetooth, cellular or other wireless or wired connection.

Control circuitry 604 may comprise processing circuitry 606 and storage 608 and may comprise I/O circuitry. Control circuitry 604 may be used to send and receive commands, requests, and other suitable data using I/O path 602, which may comprise I/O circuitry, for example, for receiving user demarcations of permitted area boundaries and for transmitting displays to be provided by the HMD of the XR device, including display of the virtual permitted area boundary and virtual partition. I/O path 602 may connect control circuitry 604 (and specifically processing circuitry 606) to one or more communications paths (described below). I/O functions may be provided by one or more of these communications paths, but are shown as a single path in FIG. 6 to avoid overcomplicating the drawing.

Control circuitry 604 may be based on any suitable control circuitry such as processing circuitry 606. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i9 processors) or multiple different processors (e.g., an Intel Core i9 processor and an Intel Core i7 processor). In some embodiments, control circuitry 604 executes instructions for the XR application stored in memory (e.g., storage 608). Specifically, control circuitry 604 may be instructed by the XR application to perform the functions discussed above and below. In some implementations, processing or actions performed by control circuitry 604 may be based on instructions received from the XR application.

In client/server-based embodiments, control circuitry 604 may include communications circuitry suitable for communicating with other networks. The XR application may be implemented as software or as a set of executable instructions. The instructions for performing any of the embodiments discussed herein of the XR application may be encoded on non-transitory computer-readable media (e.g., a hard drive, random-access memory on a DRAM integrated circuit, read-only memory etc.). For example, in FIG. 6, the instructions may be stored in storage 608, and executed by control circuitry 604 of a device 600.

In some embodiments, the XR application may be a client/server application where only the client application resides on device 600, and a server application resides on an external device or edge service network. Control circuitry 604 may include communications circuitry suitable for communicating with a server, edge service computing systems and devices, a table or database server, or other networks or servers. Such communications may involve the internet or any other suitable communication networks or paths. In addition, communications circuitry may include circuitry that enables peer-to-peer communication of user equipment devices, or communication of user equipment devices in locations remote from each other (described in more detail below).

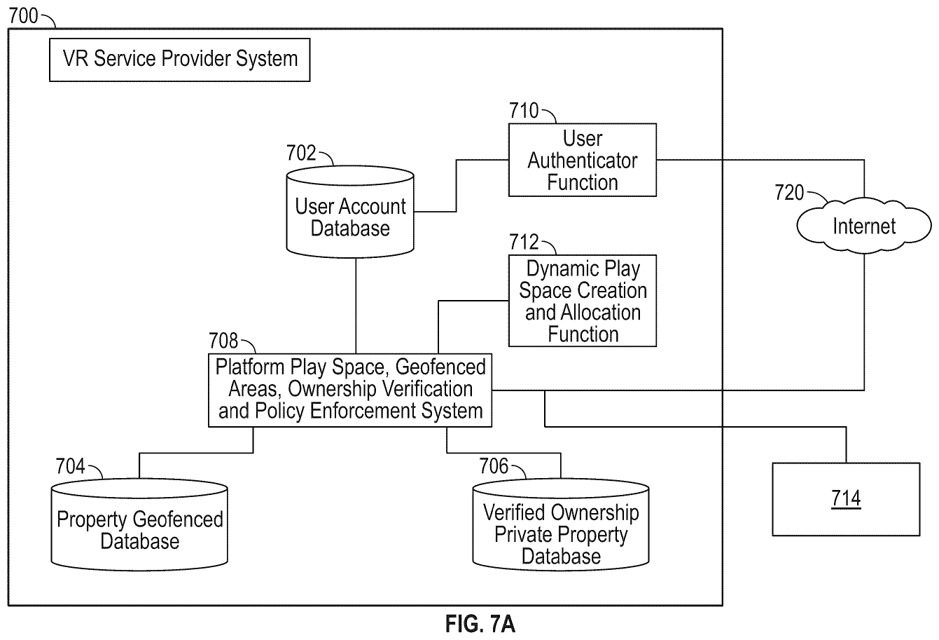

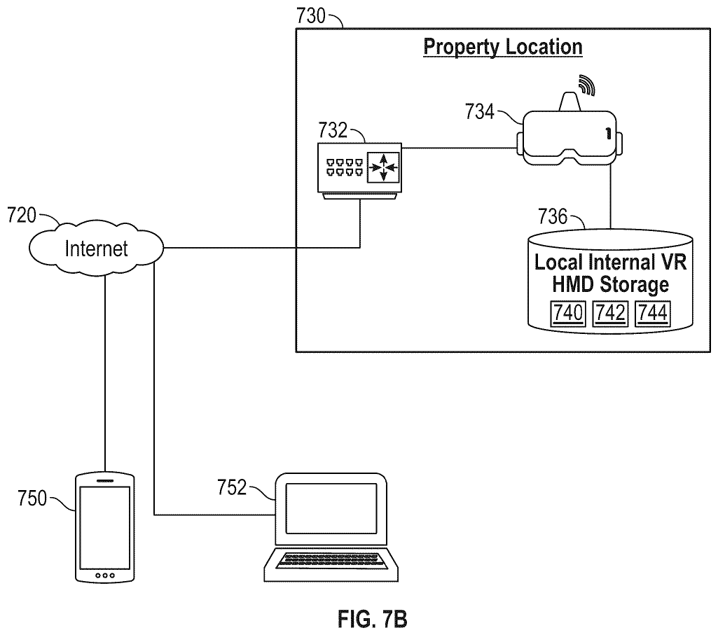

Memory may be an electronic storage device provided as storage 608 that is part of control circuitry 604. As referred to herein, the phrase “electronic storage device” or “storage device” should be understood to mean any device for storing electronic data, computer software, or firmware, such as random-access memory, read-only memory, hard drives, optical drives, digital video recorders, solid state devices, quantum storage devices, gaming consoles, or any other suitable fixed or removable storage devices, and/or any combination of the same. Storage 608 may be used to store various types of content described herein as well as VR application data described above. Nonvolatile memory may also be used (e.g., to launch a boot-up routine and other instructions). Cloud-based storage, described in relation to FIG. 7B, may be used to supplement storage 608 or instead of storage 608.

Control circuitry 604 may include video generating circuitry and tuning circuitry. Control circuitry 604 may also include scaler circuitry for upconverting and down converting content into the preferred output format of equipment 600. Control circuitry 604 may also include digital-to-analog converter circuitry and analog-to-digital converter circuitry for converting between digital and analog signals. In some embodiments all elements of system 600 may be inside housing of the XR display device 618. In some embodiments, XR display device 618 comprises a camera (or a camera array) 656. Video cameras 656 may be integrated with the equipment or externally connected. One or more of cameras 656 may be a digital camera comprising a charge-coupled device (CCD) and/or a complementary metal-oxide semiconductor (CMOS) image sensor. In some embodiments, one or more of cameras 656 may be directed at outside physical environment (e.g., two cameras may be pointed outward to capture two parallax views of the physical environment). In some embodiments, XR display device 618 may comprise other biometric sensors to measure eye rotation (e.g., electrodes to measure eye muscle contractions). XR display device 618 may also comprise range imager 654 (e.g., LASER or LIDAR) for computing distance of devices by bouncing the light of the objects and measuring delay in return (e.g., using cameras 656). In some embodiments, XR display device 618 comprises left display 650, right display 652 (or both) for generating VST images, or see-through XR images.

The XR application may be implemented using any suitable architecture. For example, it may be a stand-alone application wholly-implemented on each one of user equipment device 600 and user equipment device 601. In such an approach, instructions of the application may be stored locally (e.g., in storage 608), and data for use by the application is downloaded on a periodic basis (e.g., from the edge service network, from an out-of-band feed, from an Internet resource, or using another suitable approach). Control circuitry 604 may retrieve instructions of the application from storage 608 and process the instructions to provide XR generation functionality and perform any of the actions discussed herein. Based on the processed instructions, control circuitry 604 may determine what action to perform when input is received from user input interface 610. For example, head movement or movement of a hand or handheld device via user input interface 610. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

In some embodiments, the XR application may be downloaded and interpreted or otherwise run by an interpreter or virtual machine (run by control circuitry 604). In some embodiments, the XR application may be encoded in the ETV Binary Interchange Format (EBIF), received by control circuitry 604 as part of a suitable feed, and interpreted by a user agent running on control circuitry 604. For example, the XR application may be an EBIF application. In some embodiments, the XR application may be defined by a series of JAVA- based files that are received and run by a local virtual machine or other suitable middleware executed by control circuitry 604. Although communications paths are not drawn between user equipment devices, these devices may communicate directly with each other via communications paths as well as other short-range, point-to-point communications paths, such as USB cables, IEEE 1394 cables, wireless paths (e.g., Bluetooth, infrared, IEEE 602-11x, etc.), or other short-range communication via wired or wireless paths. The user equipment devices may also communicate with each other directly through an indirect path via communication network.

While sometimes described as a “XR” network or system by way of example, it will be understood that implementations that include SLAM (Simultaneous Location And Mapping) technology, are also contemplated. SLAM technology allows a variety of devices, including XR equipment, HMDs, wearable devices, industrial robots, autonomous household devices, drones, self-driving vehicles, etc., to create a map of its surroundings and to locate and assist in autonomous and/or user-assisted navigation based on the map in real time. Example XR devices include XR devices, VR devices, AR devices, and MR devices. The field of view may comprise a pair of 2D images to create a stereoscopic view in the case of an XR device; in the case of an AR device (e.g., smart glasses), the field of view may comprise 3D or 2D images, which may include a mix of real objects and virtual objects overlaid on top of the real objects using the AR device (e.g., for smart glasses, a picture captured with a camera and content added by the smart glasses). For example, in an embodiment, the system may provide virtual boundaries of the permitted area, and possibly other virtual elements of a scene for display, while the actual or real-world environment may also be displayed or be visible. In addition, equipment sold for or typically usable for MR or AR may be compatible with a system as herein discussed by displaying virtual elements of a scene, such as virtual boundaries. A map of an area may be generated based on sensor data captured by sensors onboard the SLAM-enabled device, and the location of the SLAM-enabled device on the map may be determined based on data generated by the device. One or more sensors may be positioned in, on, or at the SLAM-enabled device, or may be positioned elsewhere and capture a field of view of the SLAM-enabled device. For example, one or more stationary cameras in the vicinity of the SLAM-enabled device may provide image data, in addition to or instead of, cameras onboard the SLAM-enabled device. The device's sensors, such as one or more charge coupled devices and/or cameras and/or RADAR/LIDAR and the like, or a combination of the foregoing, collect visual data from the physical world in terms of reference points. In addition, or instead, a SLAM-enabled device may also use one or more of GPS data, satellite data, wireless network and/or Wi-Fi signal strength detection, acoustic signals, or any suitable visual positioning system (VPS) methods, e.g., using other previously scanned objects as anchors, or using any other suitable technique, or any combination thereof for determining location, movement and/or orientation. For example, a Wi-Fi positioning system (WPS or WiPS) may use Wi-Fi hotspots or other wireless access points to locate a device. An SSID (Service Set Identifier) and MAC (Media Access Control) address assigned to a NIC (Network Access Controller) may be used as parameters for locating the device in a WPS. A SLAM-enabled device may be equipped with IMU (inertial measurement unit). IMU data may be used for location/orientation/movement determination.

FIG. 7A-7B are network diagrams illustrating a VR service provider system 700 communicating with a property owner devices and user devices, in accordance with some embodiments of the disclosure. As shown in FIG. 7A, the VR service provider system 700 includes a number of databases and sub-systems configured to generate, store, and communicate user and property data. In an embodiment, the VR service provider system 700 includes a user account database 702, a property geofenced database 704, a verified ownership private property database 706, and a platform play space, geofenced areas, ownership verification and policy enforcement system (“enforcement system”) 708. Additionally, the VR service provider system 700 is configured to perform a user authentication function 710 and a dynamic play space creation and allocation function 712, and access systems providing external geolocation/GPS coordinates for property records, public records, and government access.

The user account database 702 includes user records, such as user account data, user IDs, associated property IDs, associated user device IDs, and the like. The user account database 702 may be further configured to authenticate users via the user authentication function 710, which may include receiving, via the internet 720, a device user authentication request with user credentials and transmitting an authentication response with a unique user ID to the requesting device. The user records of the user account database 702 may be transmitted to the enforcement system 708 for further processing.

The property geofenced database 704 includes property records, including geolocation data, spatial coordinate data, play space and permitted area data, and user data associated with a specific location. Multiple property records for multiple properties are stored and accessible from the property geofenced database 704, e.g., for use within the VR service provider system 700.

The verified ownership private property database 706 includes ownership records, such as property ownership data associating one or more owners with one or more properties, stored GPS location coordinated, property IDs, and geofenced policies.

The enforcement system 708 is configured to transmit and receive relevant data, e.g., to an XR device or a user device, via a network connection such as the internet 720. For example, owner verification requests, property location requests, property ownership requests and play space generation requests may be received by the enforcement system 708, and responses to such requests may be transmitted by the enforcement system 708. Additionally, the enforcement system 708 is further configured to request and receive external data, such as geolocation/GPS data, public property records, and the like, e.g., from government or data provider websites.

As show in FIG. 7B, a property location 730 may be associated with a number of devices, including a property owner's device 734, such as an XR or VR device, and local storage 736. The property location devices are configured to connect to the VR service provider system 700 of FIG. 7A via a network connection, such as through the internet 720 accessed locally through a router 732 or similar networking device. In an embodiment, a property owner's device 734 connects to the local storage 736 to access locally stored geolocation data 740, locally stored VR applications 742, usage and permission policies 744, and the like.

Additionally, a user device such as a mobile phone 750 or personal computer 752 may be used to access the VR service provider system 700 via the internet 720. For example, the user device my create a user account, exchange user credentials for authentication, access and update location policies associated with a user account, and the like.

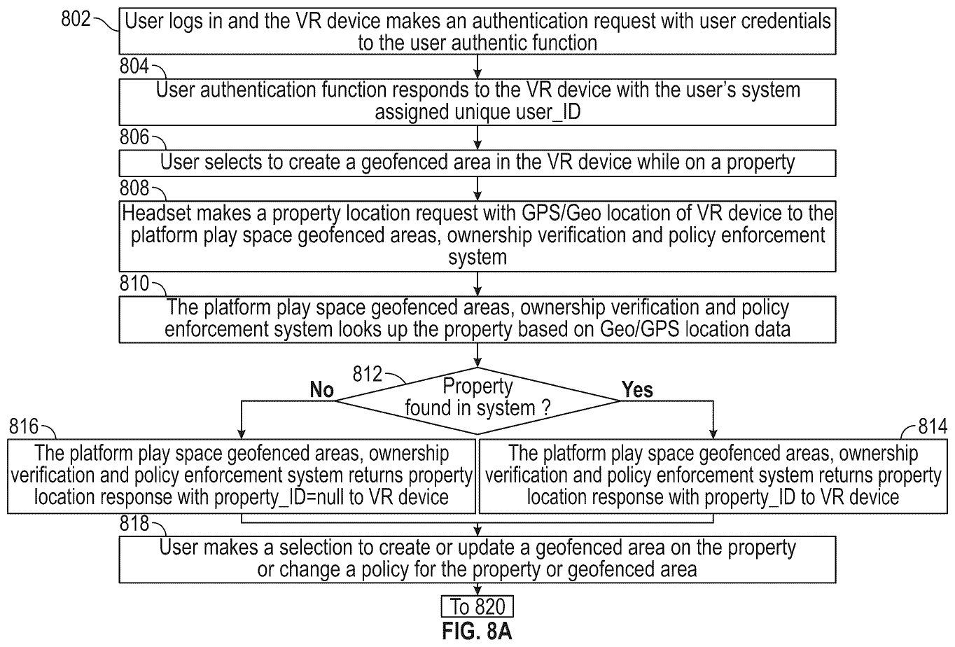

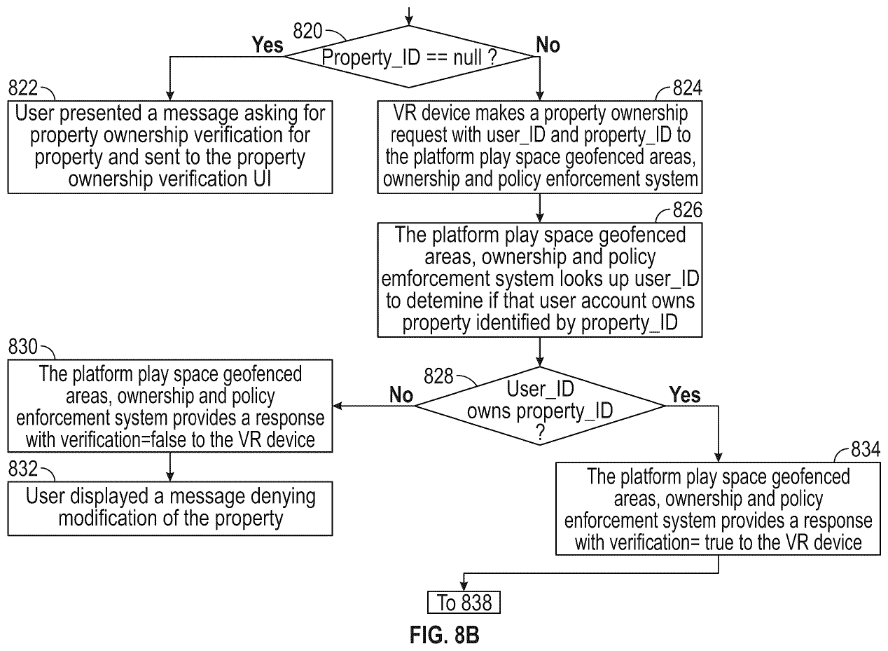

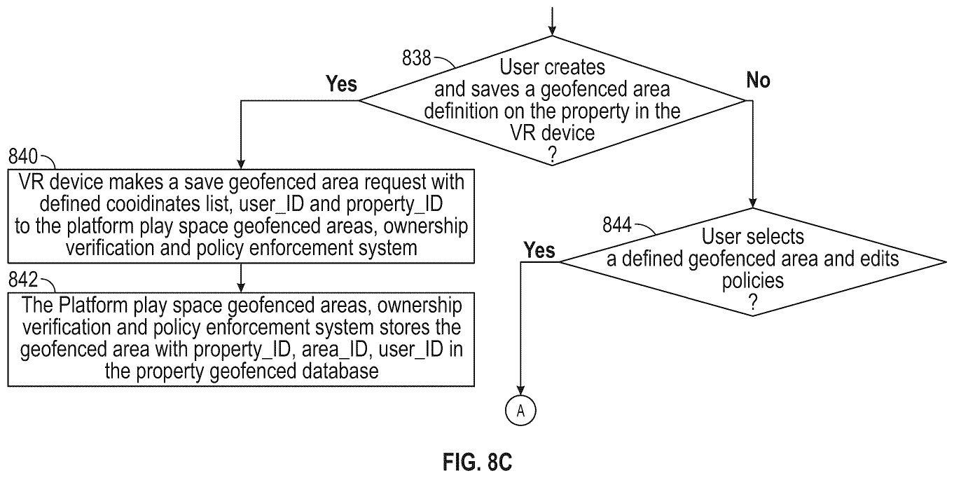

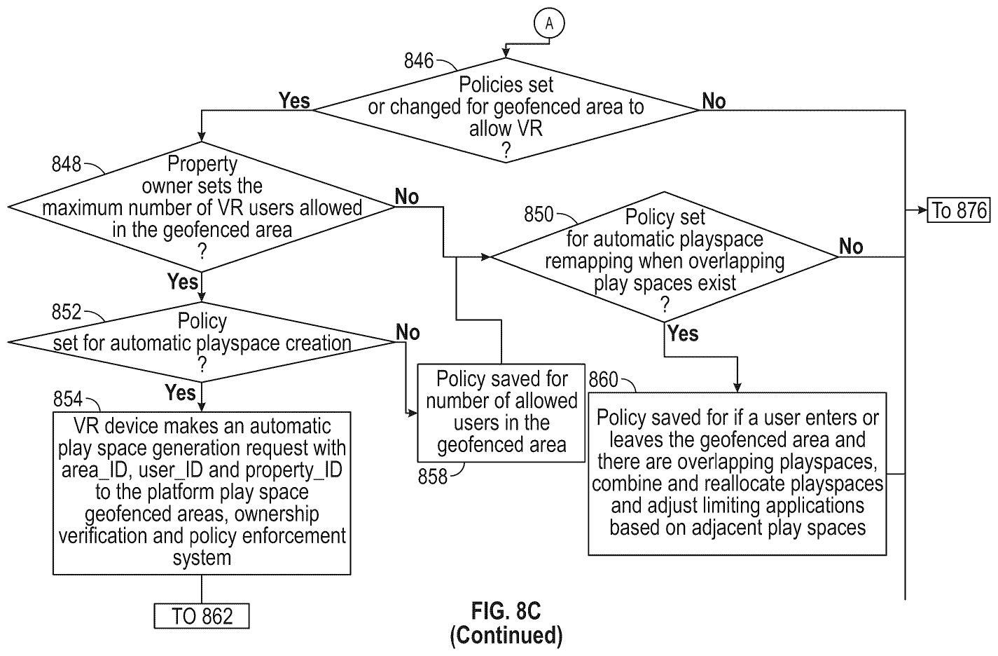

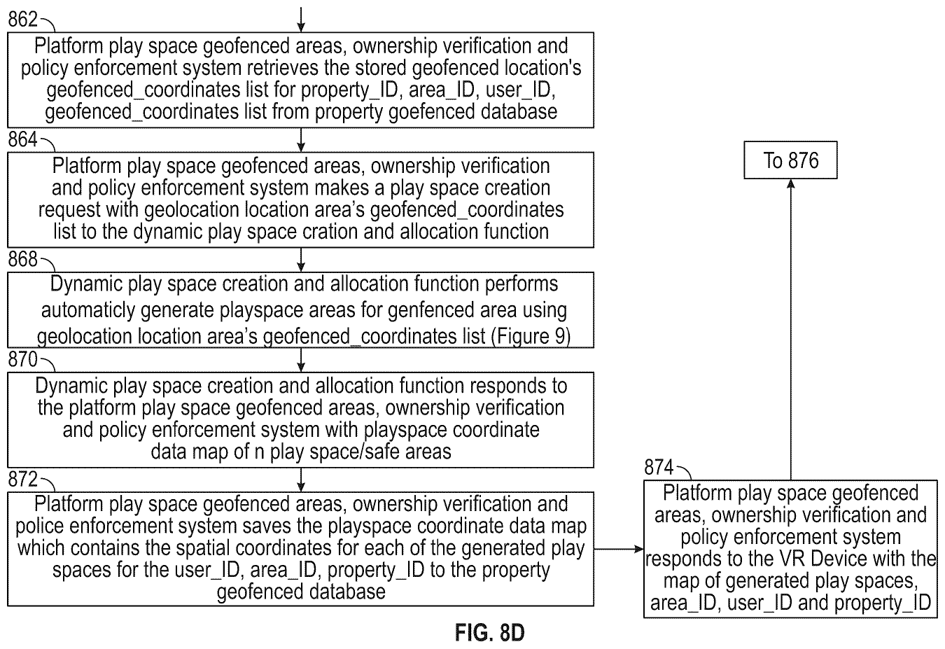

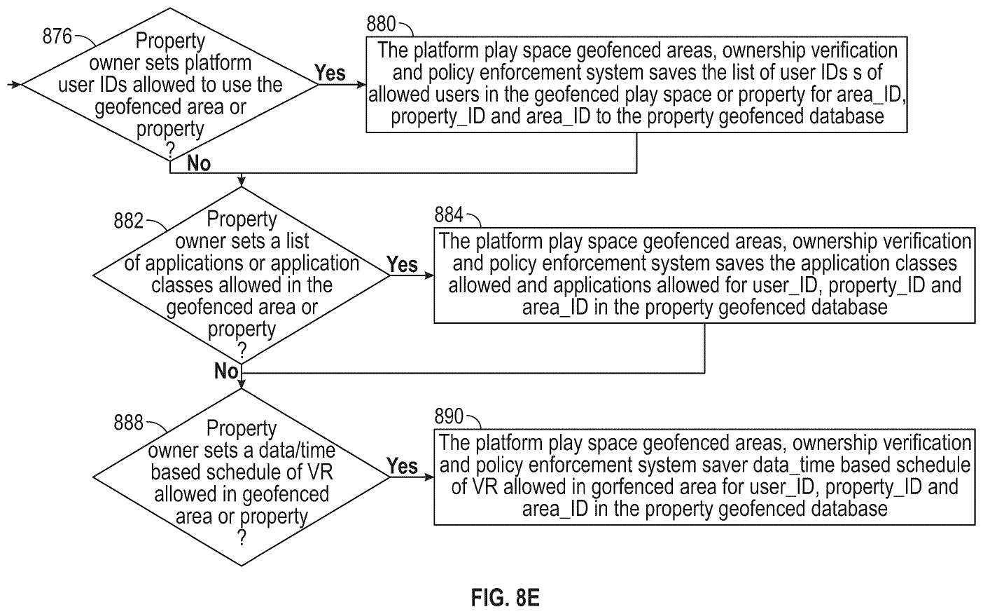

FIGS. 8A-E are flowcharts of a method for creating a geofenced area for XR device usage, and for defining and updating permitted and prohibited areas, in accordance with some embodiments of the disclosure.

In FIG. 8A, the method begins at 802 where an XR device user logs into an XR service, e.g., via an internet or cellular network connection, and transmits an authentication request to the XR service using user credentials to initiate a user authentication function. At 804, the user authentication function is received by the XR system and a response including a unique user ID is received by the XR device. In some embodiments, at 806, the user is prompted to designate permitted areas, while in other embodiments a predetermined XR device usage policy is requested and received from an XR administrator. At 808, a location data request of the XR device is transmitted to the XR service, e.g., using GPS location coordinates or similar location functionality, and at 810 ownership verification and policy enforcement is performed, e.g., by the XR system, based on the location data received.

At 812, it is determined if the property corresponding to the physical location of the XR device is found within the XR system. If so, a response is returned from the XR server at 814 with a previously assigned unique property ID. If not, a null response is returned from the XR server to the VR device at 816. At 818, the XR device user, or in some embodiments an XR administrator, selects a desired permitted area or sends a request for a different permitted area to the XR system for approval by the XR administrator. The user may select to either create a geofenced area for the property (e.g., if one doesn't exist, set property_ID=null) or if the property_ID is not null, the user may change the policies (e.g., permitted application, enable or disable VR or XR usage, and the like) for the entirety of a property location.

Continuing in FIG. 8B, it is determined if a null response is received at 820. If a property null response is received, the XR device displays a message requesting property ownership verification and the method ends at 822. If a unique property ID has been received at 814, the method continues with 824 where the XR device transmits a property ownership request with the unique user ID and property ID to the XR system, and at 826 the XR system determines if a user is a property owner and permitted to institute property polices. Continuing at 828, a determination is made, e.g., via verification from a database, regarding if the user ID is identified as an owner of the property ID. If so, at 834 the XR system provides a positive verification result to the XR device and the method continues at 838 in FIG. 8C. If the user is not identified as an owner of the property, a negative verification result is received at 830 with a verification=false response, and at 832 a message denying modification of the property is displayed on the XR device.

In FIG. 8C, at 838, it is determined if the verified user has created and saved an updated geofenced defined area. If so, a request to save the updated geofenced area for future access, e.g., to the XR server, is made at 840 and the save function is performed at 842. If no update of a geofenced area is made, a previously defined geofenced area is selected at 844, and at 846 it is determined if any changes to policies regarding XR usage within the selected area have been made. If not, the method continues at 876 of FIG. 8E. If changes in policies have been made, it is determined if an XR administrator has requested to set a maximum number of XR device users at 848. If not, a determination if automatic remapping is enabled is performed at 850 and if such remapping is not enabled, the method continues at 876 in FIG. 8E. If automatic remapping is enabled, a policy update based on the number of XR devices within a physical space is performed at 860 and the method continues at 876 in FIG. 8E. If an XR administrator has requested to set a maximum number of XR device users at 848, the method continues at 852 where a determination if automatic permitted area creation is enabled is performed. If not, a policy for allowed number of users is set at 858 and the method continues at 850. If automatic permitted area creation is enabled, an XR device places an automatic play space generation request in the permitted area to the XR system server, e.g., the enforcement system 708 of FIG. 7A, and the method continues at 862 in FIG. 8D.

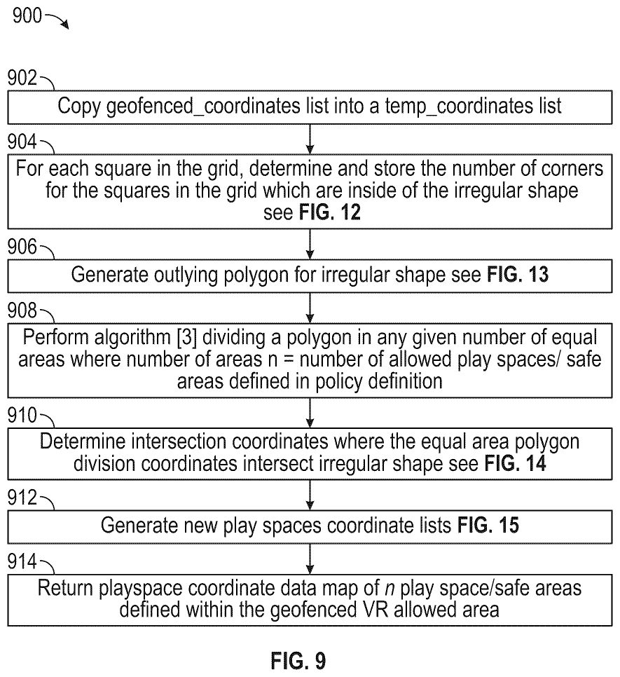

In FIG. 8D, at 862, location coordinates of the XR device and records of the property ID, user ID, and area ID are retrieved from a database, and at 864 a permitted area creation request is performed. At 868, the permitted area is dynamically generated, as further discussed in FIG. 9 below, and at 870 a dynamic map of the permitted and prohibited areas of the physical space that have been automatically generated is provided to the enforcement system. At 872 the generated map containing the property ID, user ID, and area ID is saved, and at 874 the map is transmitted to the XR device. The method then continues at 876 in FIG. 8E.

In FIG. 8E, it is determined if the XR administrator has assigned allowed user IDs at 876. If so, the list of assigned allowed user IDs is saved to the XR server and the method continues at 882. If not, the method continues at 882. At 882, it is determined if the XR administrator has set a list of allowed applications, application types, scheduled times, areas, and the like. If so, the updated lists of allowed applications, application types, scheduled times, areas, and the like is saved to the XR server and the method continues at 888. If not, the method continues at 888. At 888, the updated schedule of permitted XR device use is saved to the XR server and the method ends.

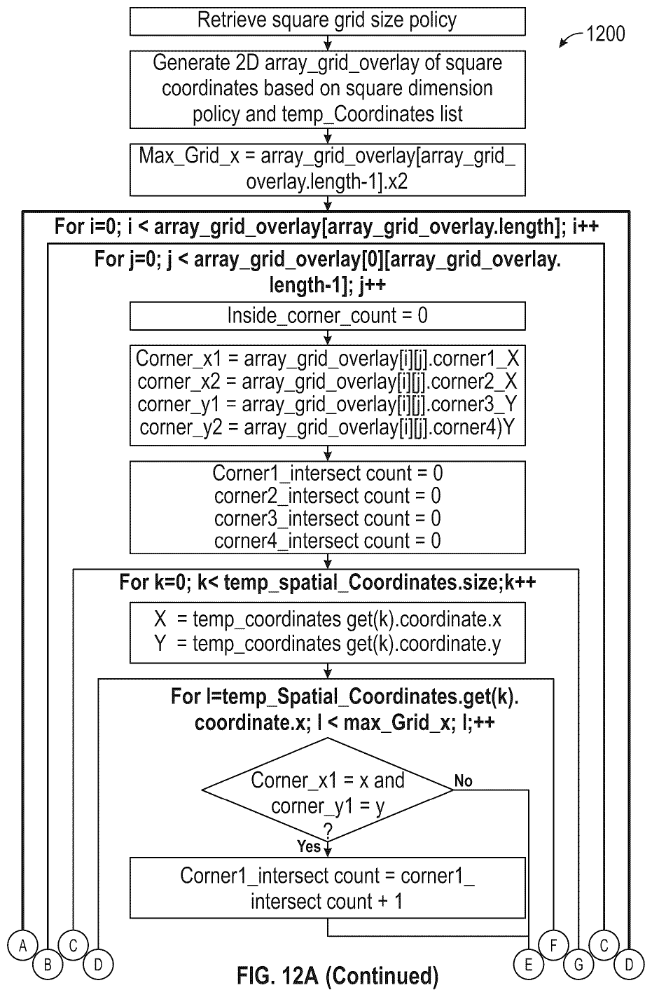

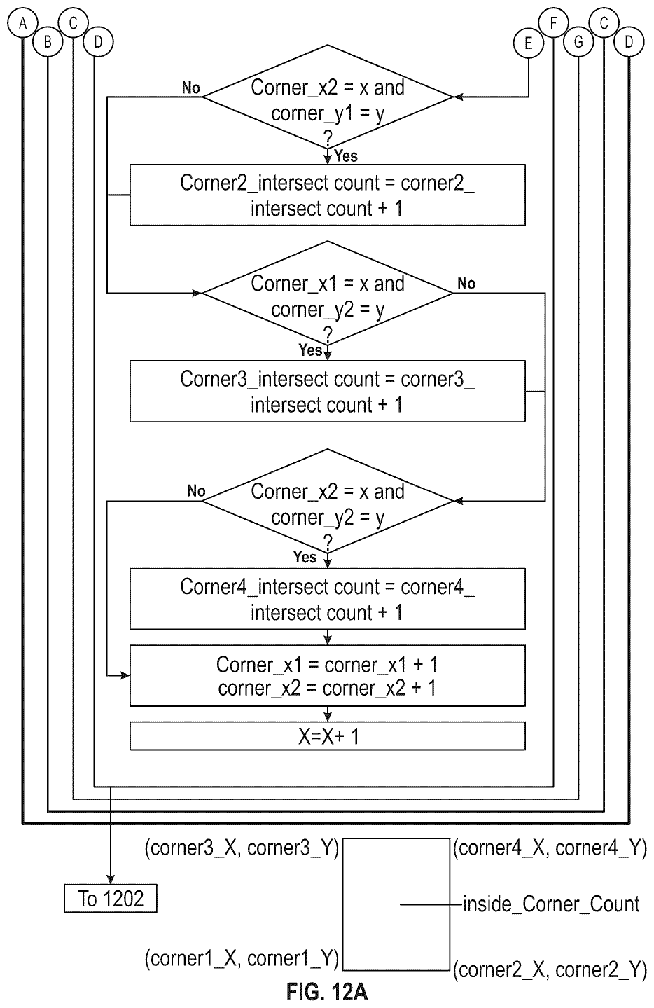

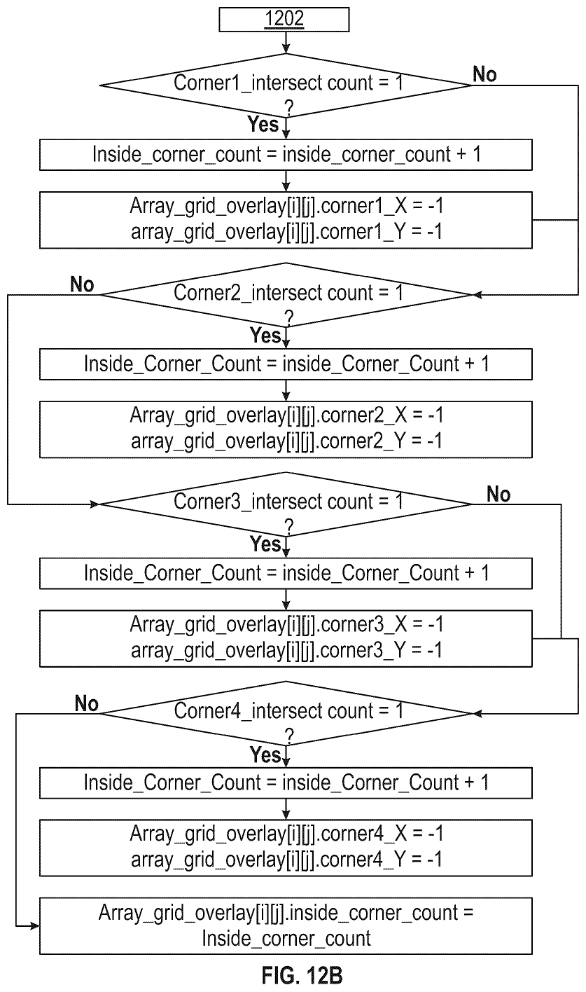

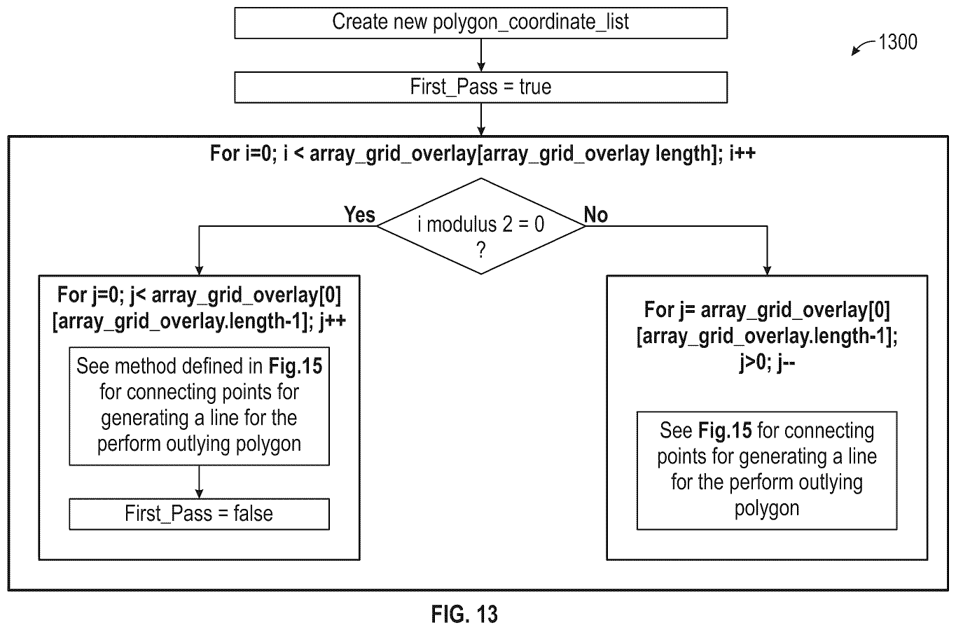

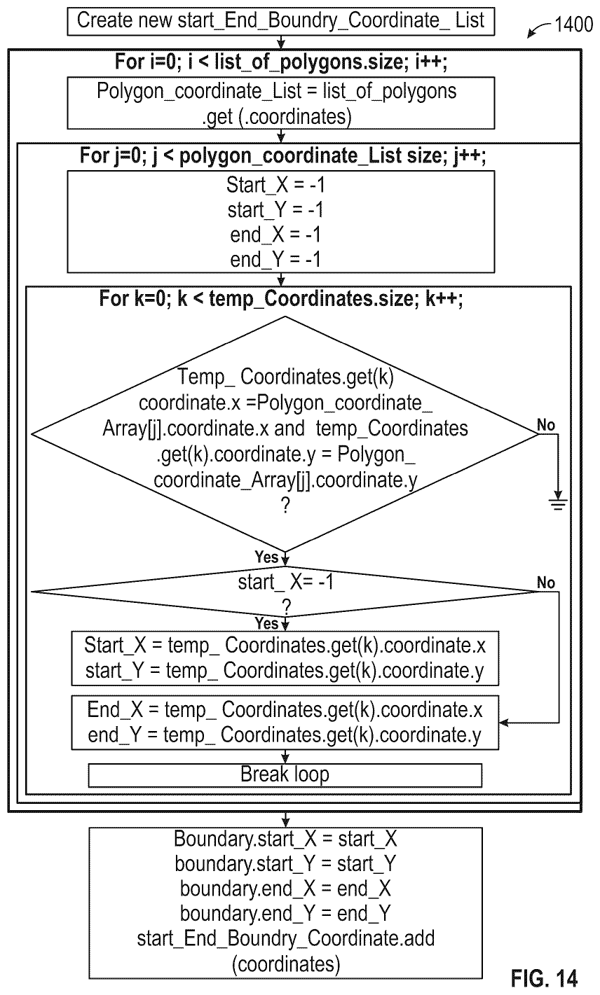

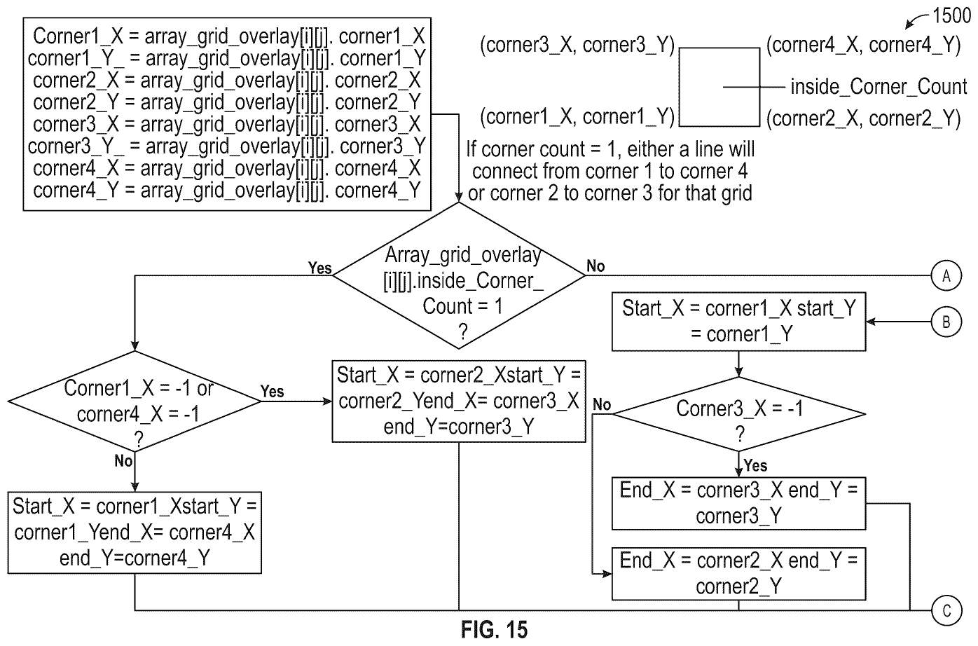

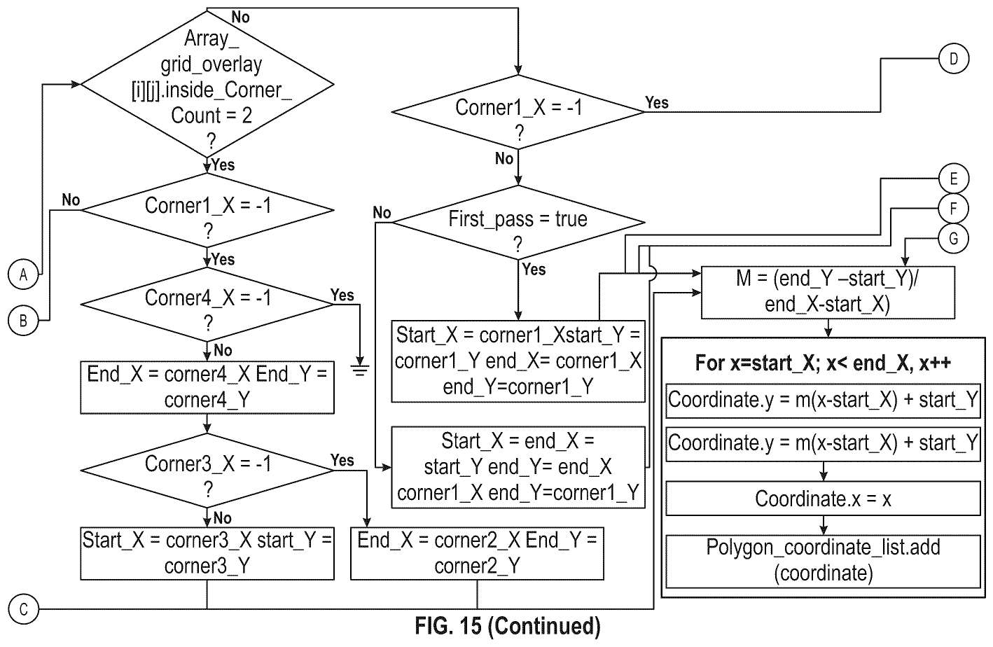

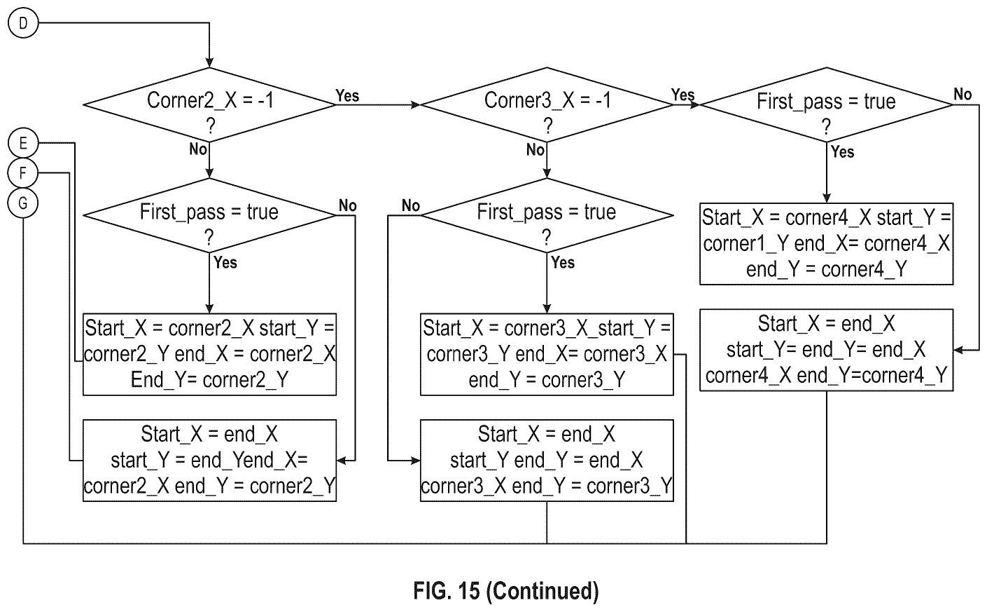

FIG. 9 is a flowchart of a method 900 for automatically generating play space areas, in accordance with some embodiments of the disclosure. The automatic generation of play space area can be initiated as part of a larger method, e.g., at step 868 of the method described in FIG. 8D discussed above. At 902, a list of geofenced coordinates for a location is retrieved and copied, e.g., into a temporary list. At 904, the number of corners of squares within a generated grid for the location are determined and stored, as shown further below in FIGS. 12A-12B. At 906, an outlying polygon for an irregular shape is generated, as shown further below in FIG. 13 and above in FIG. 5B. At 908, an algorithm is performed to divide the outlying polygon into a determined number of equal areas, and at 910 intersection coordinates where equally-sized area division coordinates intersect with the irregular shape of the polygon is determined, as shown further below in FIG. 14. At 912, a new play space area is generated, as shown further below in FIG. 15, and at 914 a play space coordinate data map of n play spaces or permitted area is returned, e.g., to the requesting device or system.

In an embodiment, the generation of play spaces or guardian boundaries in certain places are limited to specific times (e.g., after 6 PM). In further embodiments, generated play space settings are associated with a particular property (e.g., a home, a gym, etc.) and with an assigned XR administrator and an account owner that manages rules and defines areas within the play space. The account owner can modify such rules, e.g., the times during which generation of play spaces is permitted, based on requests received from users via notifications on any device associated with the account owner.

As an illustrative example, an account owner might receive a notification requesting additional time for use of an XR device if the current rules associated with the play space have a time constraint. For example, the XR device can permit users to request additional time to finish a game or finish a movie. This feature enables the systems to send a notification to the owner requesting additional time (e.g., “Tom requests 20 more minutes to finish watching the movie,” or “Tom requests 10 additional minutes to finish his workout,” etc.). The construction of the notification can include real-time metadata (i.e., the remaining time needed to complete a task) from an application that is currently being executed on the XR device. In a further embodiment, an XR device can send an unlock request to the entity that manages the play space rules. For example, a parent has designated an area in a house that cannot be used as play space because it is deemed unsafe for being occupied with furniture. However, there may be scenarios where some of the furniture has been moved and is no longer present. A newly available portion of the room is now available to be used as a play space area, but the play space settings must be updated. An XR device user can send a request to the play space owner to permit the newly available area for use within the play space.

In a further embodiment, the creation of a play space can be conditional on specific factors. For example, a parent can enforce rules regarding play spaces based on factors such as the completion of a task. As an illustrative example, data from a school application, e.g., executed on a work device such as a student laptop, is communicated with an XR server or XR cloud service regarding the student's completion of a homework assignment, and a play space can be created if the data from the school application indicates that the assignment has been completed.

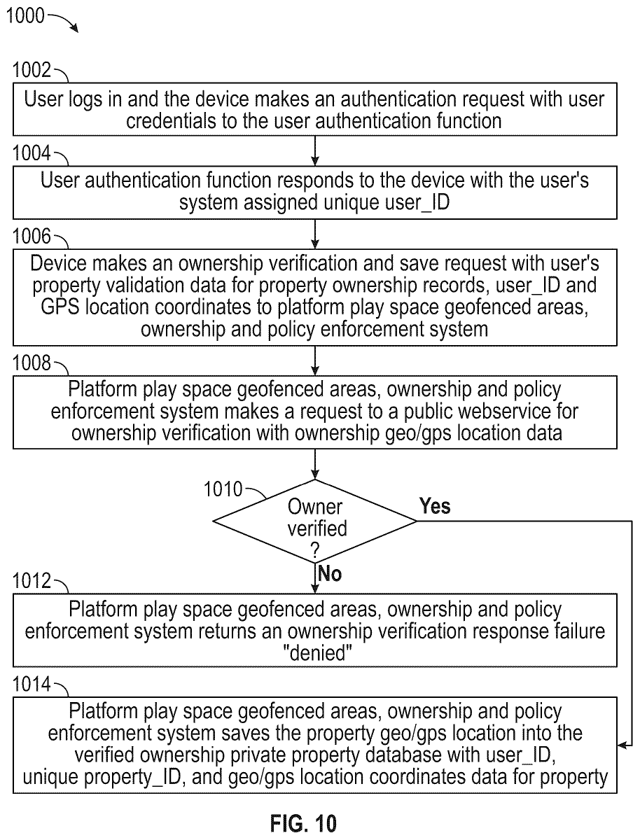

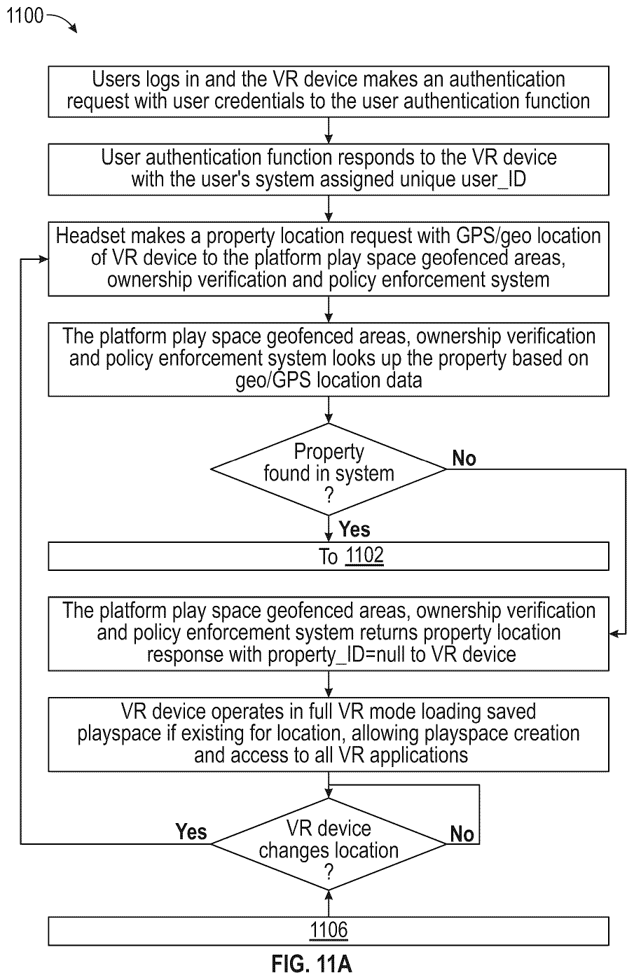

FIG. 10 is a flowchart of a method 1000 for claiming property ownership of a property for use with an XR system, in accordance with some embodiments of the disclosure. At 1002 a user authentication request, with user credentials, is transmitted, e.g., from a user XR device to an XR system via a network connection. At 1004, a user authentication function responds with an assigned unique user ID. At 1006, a user device makes an ownership verification and save request with user property validation data for property ownership records, user ID and GPS location coordinates to a system, e.g., the Platform Play Space Geofenced Areas, Ownership and Policy Enforcement System (“enforcement system”) of FIG. 7A. At 1008, the enforcement system submits a request, e.g., to a public webservice, for ownership verification with ownership geolocation or GPS location data. At 1010 it is determined if an owner has been verified. If not, the enforcement system returns a denial response and the method ends. If an owner has been verified, at 1014 the enforcement system saves the property geolocation or GPS location data in a Verified Ownership Private Property Database with a user ID, a unique property ID, and geolocation or GPS location coordinates data for the property.

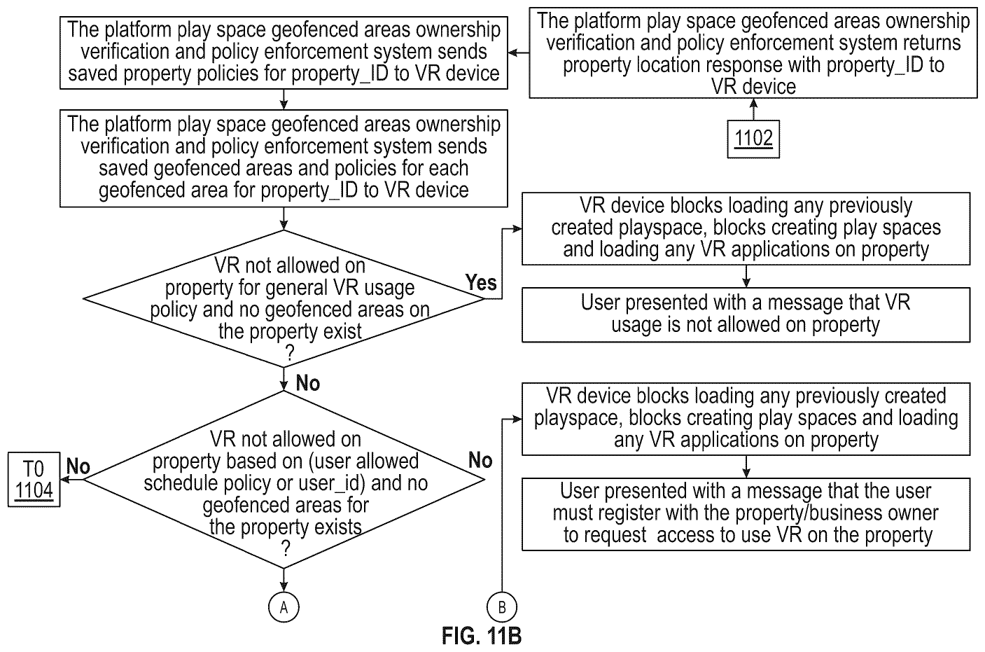

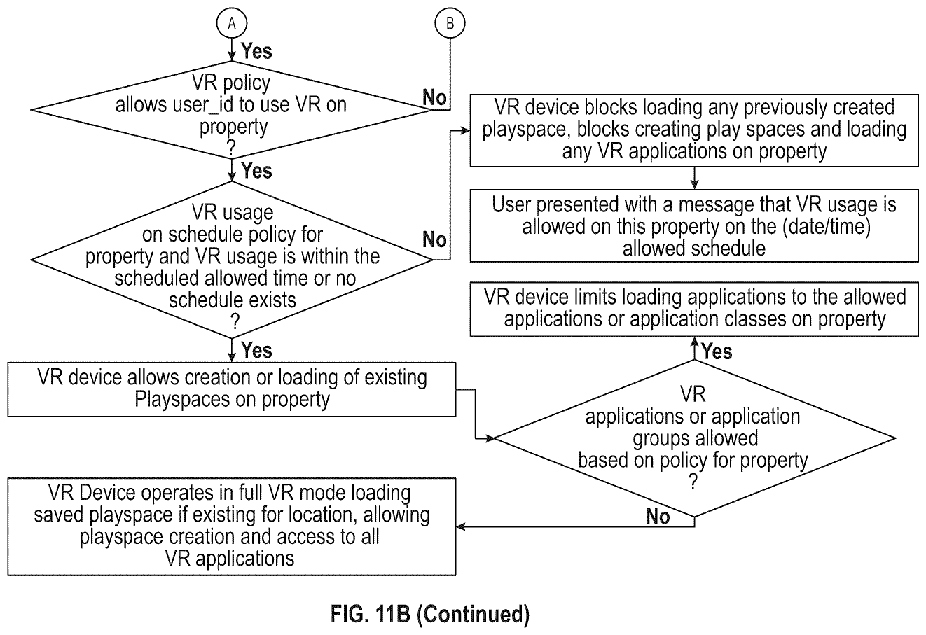

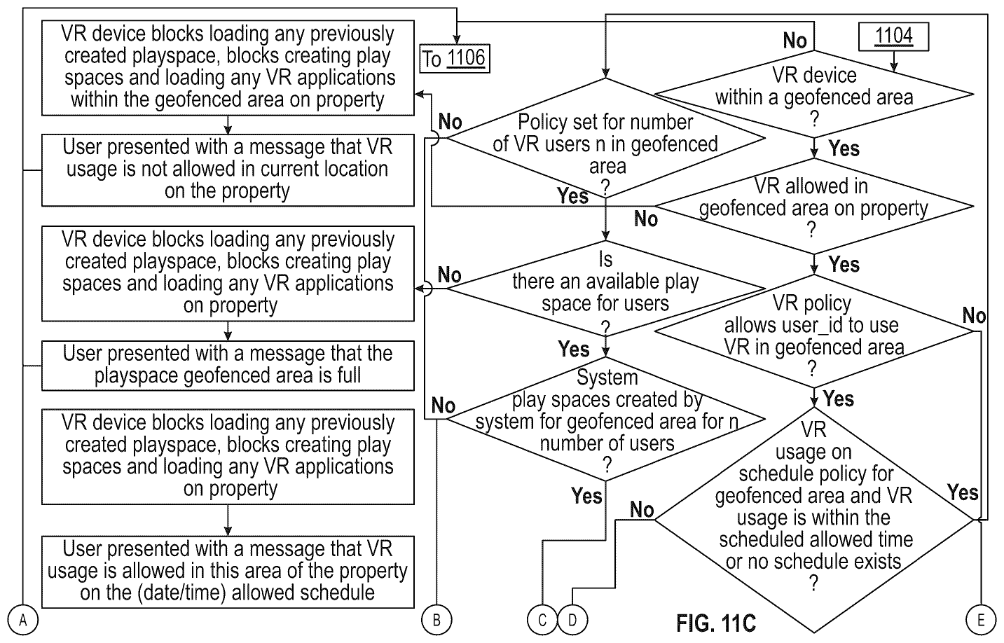

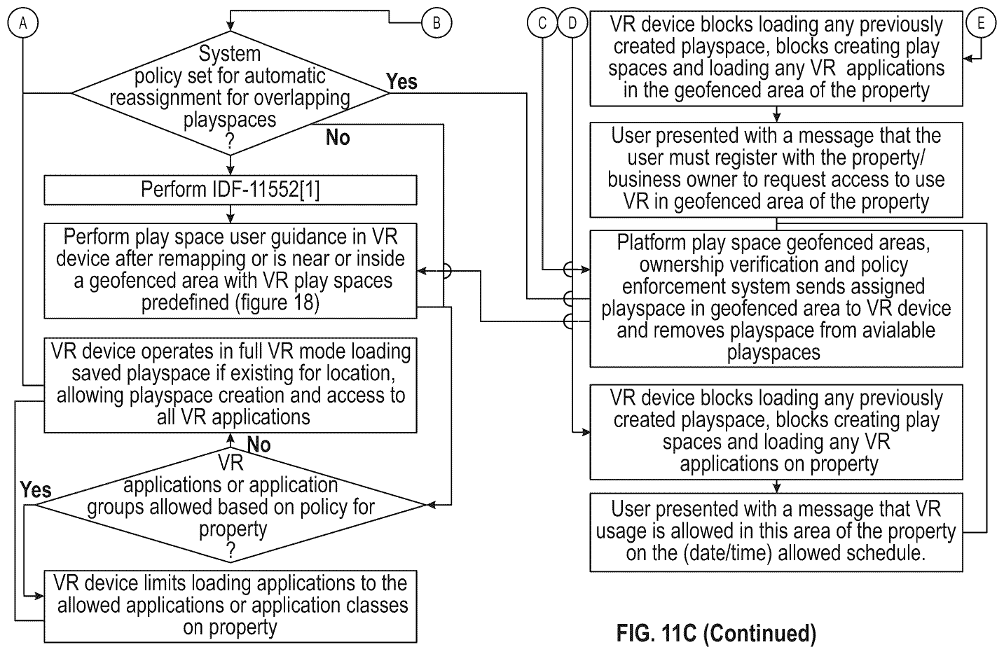

FIGS. 11A-11C are flowcharts of a method 1100 for enforcing geolocation and geofencing policies for XR users, in accordance with some embodiments of the disclosure. The steps of the method shown in FIG. 11A relate to authentication of a user, transmission of a property location request, and determination of a location change of a XR device. The steps of the method shown in FIG. 11B relate to transmission of property data to a XR device, determination of permission of usage of a XR device within a specific property, and permission of usage of the XR device within additional parameters, including time schedules, permitted and prohibited play spaces, permitted and prohibited XR applications, and the like. The steps of the method shown in FIG. 11C relate to XR policy regarding permitted XR users within a specified area, access to and loading of previously created play spaces, and the like.

FIGS. 12A-12B are flowcharts of a method 1200 for determining and saving grid corners in irregular play spaces, in accordance with some embodiments of the disclosure. FIG. 12A relates to steps for retrieving a square grid policy and generating a two dimensional array of square coordinated based on a dimension policy and a temporary coordinate list. The steps include identifying and comparing the corner coordinates as shown in the FIG. 12B shows the continuation of the method, which includes determining a number of corners that fall into the irregular shape of a polygon of a permitted area of XR device use.

FIG. 13 is a flowchart of a method 1300 for generating an outlying polygon, in accordance with some embodiments of the disclosure. The method includes determining a modulus, or remainder, of a variable i in the generation of a line in an outlying polygon.

FIG. 14 is a flowchart of a method 1400 for determining and saving intersection boundary coordinates of an irregular polygon, in accordance with some embodiments of the disclosure. Such an irregular polygon is shown above in FIGS. 5A-5C and FIG. 9.

FIG. 15 is a flowchart of a method 1500 for generating poly line segment coordinates, in accordance with some embodiments of the disclosure. An array of corner coordinates is received and a number of corners within an associated polygon is determined. If a corner count is determined to be 2 and it is the first pass within the method, there is no line present, the start and end x values and start and end y values will be the same, and the values are only saved and the last loop will not be executed. If it is not the first pass within the method, a set of coordinates will be generated generating a line to connect the two points. After determining start and end coordinates for generating a line to make up the irregular polygon, the slope (m) will be calculated. Using the calculated slope, coordinates will be chosen to generate a line connecting the starting and ending coordinates to a line making up the irregular polygon.

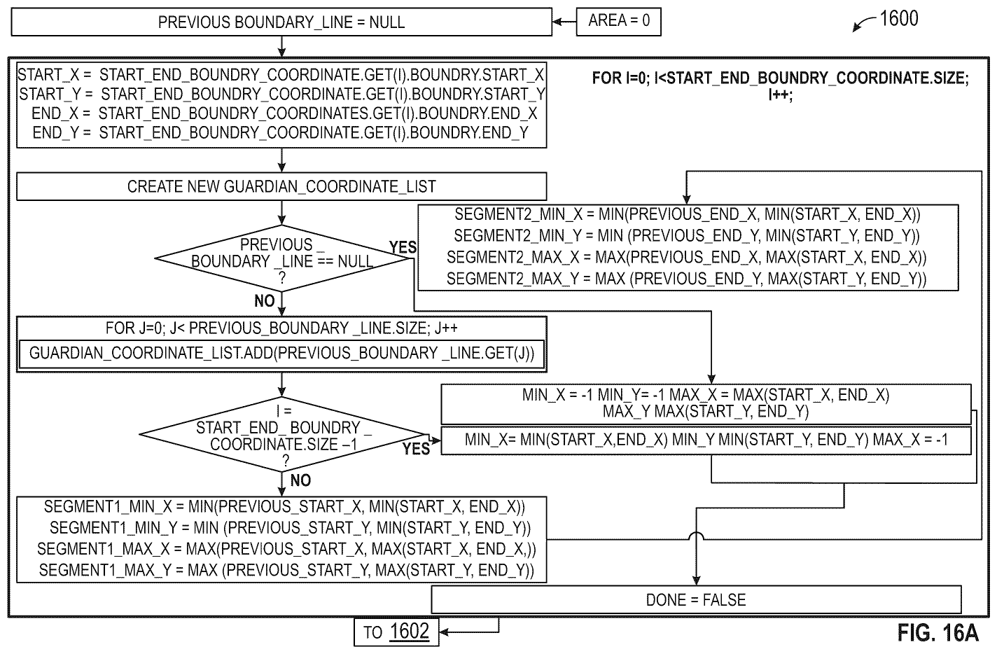

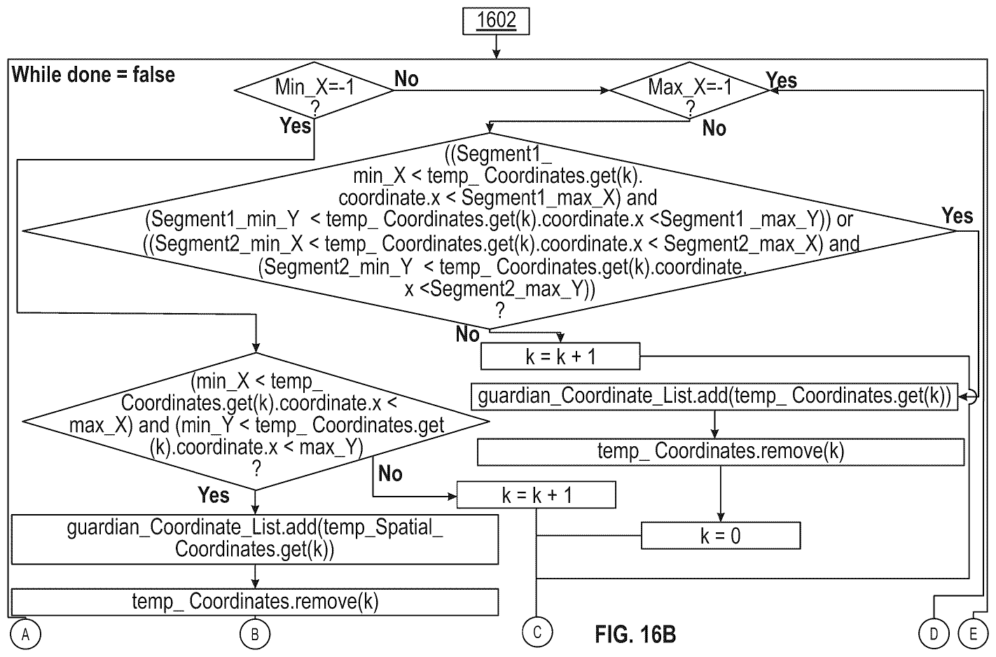

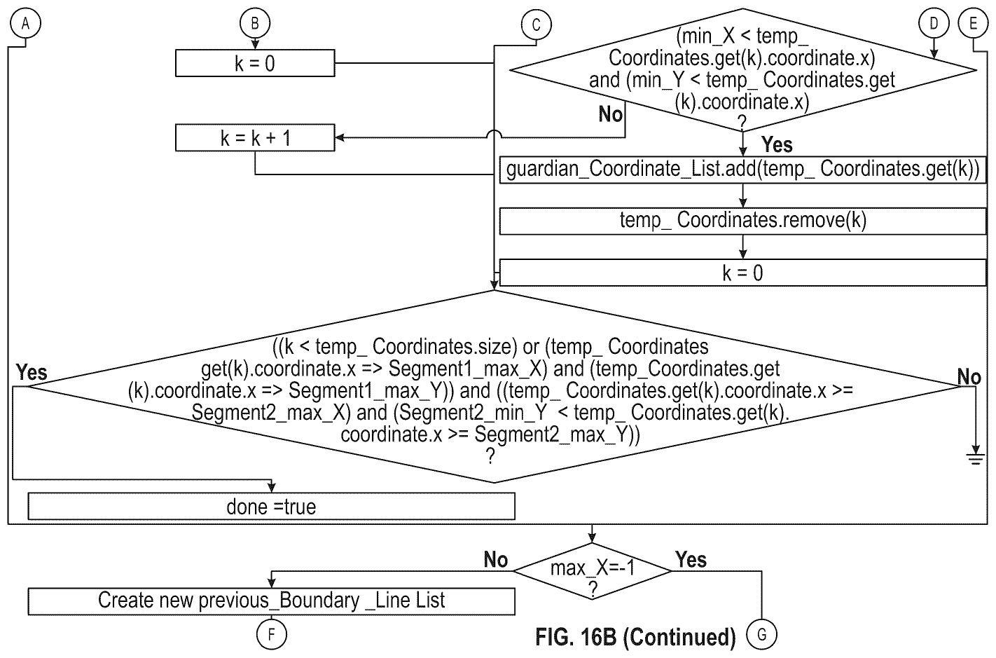

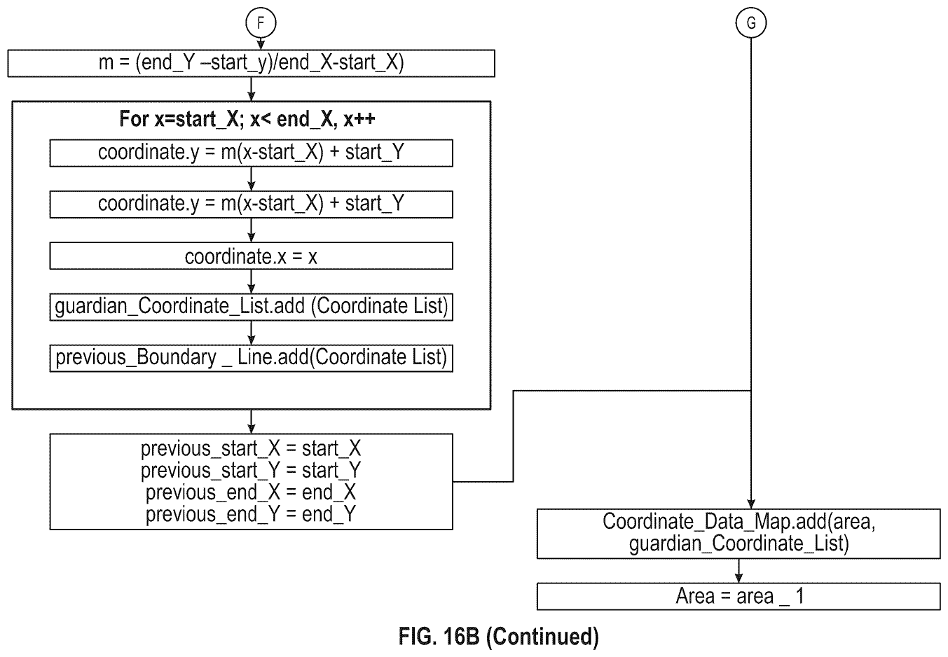

FIGS. 16A-16B are flowcharts of a method 1600 for generating new play spaces coordinate lists, in accordance with some embodiments of the disclosure. As shown in FIG. 16A, a new play space is created when a previous boundary line variable is determined to be null. If a previous boundary line is determined to exist, the previous boundary line may also be included in the new play space area. A determination of coordinates of a geofenced area is shown in FIG. 16B, including calculating a slope for generating a coordinates list dividing line and generating the coordinates list for the dividing line for two new play spaces. If needed, a new boundary line is generated by connecting the dividing coordinates where the irregular polygon divider line intersects with the irregular shape. The resulting new generated play space/safe area is added to the map, e.g., a locally stored map of XR device usage for a physical space.

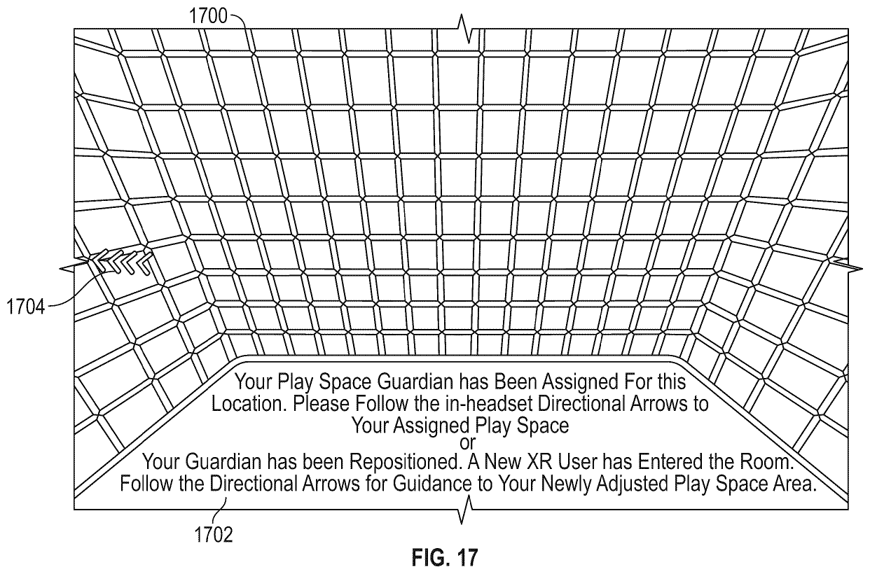

FIG. 17 is an illustrative example of a visual display of an XR device with a visual indicator directing an XR device user toward a permitted area, in accordance with some embodiments of the disclosure. An illustrative example of a user interface (UI) 1700 with XR passthrough enabled to guide an XR user to an assigned permitted area is shown. This UI may also be used to move XR users to new dynamically assigned permitted spaces when an update and adjustment to the permitted areas based on other XR users entering a physical space, or based on time or application type limitations as further discussed above, is received. The XR system may automatically generate a scene 1700 providing user guidance, such as a textual display 1702 or a direction arrow 1704, when a new XR device is detected as being active in the physical space. In an embodiment, the system may automatically generate the scene providing such guidance when a second XR device is detected in the same permitted area as the permitted area of the first XR device. In addition, or instead, the system may automatically generate a display providing such guidance when a previously detected second XR device assigned to its own permitted area is detected operating in the permitted area of the first XR device. In such a case, the system may cause such a guiding display to be shown by the errant XR device. According to an embodiment, the system may cause such a guiding display, including visual guides to indicate that some areas are off limits and to indicate a recommended direction of movement by the errant XR device, or by the newly active XR device, as well by one or more of the other XR devices active in the physical space, and/or may cause a passthrough and game halt mode also in one or more of the other XR devices. Such a user guiding display may also be accompanied by visual display of a textual notification 1702, and may include one or more audible signals or verbal audio warnings and/or by audible instructions and directions to cue XR users outside, e.g., back to the currently allocated permitted area of the XR device. As shown, a passthrough mode may be provided simultaneously with a virtual display to guide the user of the XR device.

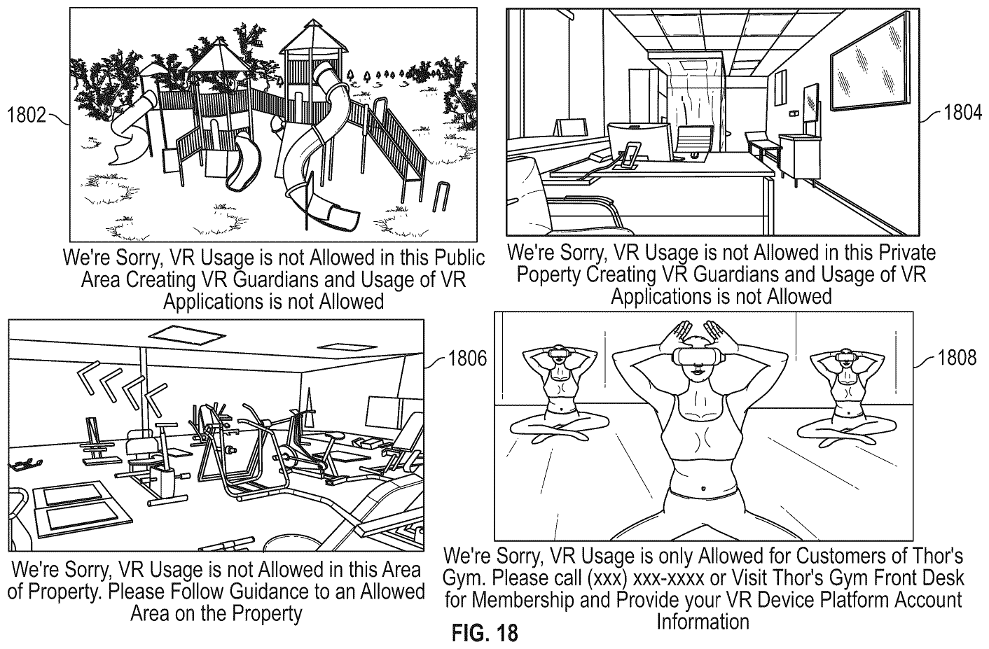

FIG. 18 illustrates examples views 1802-1808 of an XR device displaying prohibited areas, in accordance with some embodiments of the disclosure. FIG. 18 demonstrates several examples of what an XR device user might see when entering a geofenced property or a defined geofenced area on a property based on policy set for XR usage policies. In all of the shown cases, the XR headset is in passthrough mode with policy restrictions presented as on overlay. In some cases, custom user messages may be set and displayed with the policy enforcement. In view 1802, a public area, such as a playground is shown, which is designated as a prohibited area. A textual notification indicating the XR usage is not allowed in a public space is displayed, and the XR device may be configured to only operated in passthrough mode, showing a live video image of the physical space with no or very limited XR functionality allowed. Such areas may include other areas determined as off limits for XR device usage, such as near a road or sidewalk, crosswalks, school crossings, train tracks, relevant entry and exit points, and the like. In view 1804, a private area, such as a reception room in a doctor's office, is shown, which is designated as a prohibited area. A textual notification indicating the XR usage is not allowed in this private space is displayed, and the XR device may be configured to only operated in passthrough mode, showing a live video image of the physical space with no or very limited XR functionality allowed. In view 1806, a limited area, such as a gym, is shown, parts of which are designated as prohibited areas. A textual notification indicating the XR usage is not allowed in this room is displayed, while directional arrows indicating where a permitted area is located are displayed to guide a user. The XR device may be configured to operate partially in passthrough mode, showing a live video image of the physical space with limited XR functionality allowed. In view 1808, a semi-private area, such as a workout room within a gym, is shown, which is designated as a prohibited area. A textual notification indicating the XR usage is not allowed unless the associated user of the XR device is a member of a gym is displayed, and the XR device may be configured to only operated in passthrough mode, showing a live video image of the physical space with no or very limited XR functionality allowed.

In an embodiment, directed at XR or VR systems which make extensive use of passthrough imaging where a user may continuously wear the XR/VR headset during normal activities such as walking to work or school, or riding mass transit, the disclosed system employs geolocation technologies in conjunction with mapping applications to continually monitor the real-world position of the user engaged in the VR experience.

Upon detecting proximity to predefined hazardous areas, including but not limited to, roads, crosswalks, school crossings, train tracks, sidewalks, and entry or exit points, the system activates a dual-stage safety protocol. Initially, the XR device displays a notification, alerting a user to the potential danger present in their physical surroundings. In instances where the user continues to approach or does not heed the initial warning, the system advances to the second stage of the safety protocol. At this stage, the system temporarily or permanently disables the XR experience, depending on the predetermined configuration settings and the severity or type of the hazard.

The defined hazardous areas can be determined and added into the system using various methodologies. This includes governmental regulations, local municipal guidelines, property owner preferences, or other recognized safety standards. Further, the system may be customized within a settings application or user profile for determining hazardous areas, delivering user notifications, and executing responsive actions, providing a tailored experience based on user specifications or system-wide policy.

As an illustrative embodiment, an XR device worn by a user may be configured to determine a current location, e.g., based on GPS data or image analysis of images captured by the XR device in the current location. The determined location can be transmitted to an XR server, where a determination is made regarding a likelihood that the current location includes one or more hazardous areas. For example, if the user is walking down a sidewalk adjacent to a crosswalk or approaching an intersection with a train track, the XR server may be configured to cause the XR device to display a warning regarding the hazardous area, disable VR features of the XR device, turn on a passthrough mode displaying only a live feed of the current location, and the like.

In an embodiment, the XR device may communicate, e.g., through the XR server, with a real-world hazard identification and mitigation protocol configured to monitor a user's real-world location and trigger a safety alert system upon approaching predefined or currently identified hazard zones, including crosswalks, construction sites, and other public hazards. Additionally, the XR device may be associated with a user profile, where the implementation of the real-world hazard identification and mitigation protocol is adjusted based on the user profile. For example, if a user is identified as a child, the real-world hazard identification and mitigation protocol may be configured with a reduced threshold for identifying a hazardous area. Thus, in an embodiment, the XR device may permit an augmented reality display, including both a live feed view and virtual reality elements, when approaching a crosswalk when a user is identified as an adult, but prohibit any VR function, or display a warning to the user against navigating in a particular direction, when the user is identified as a child.

In an embodiment, the system may integrate with mass transit data systems, car-for-hire-services to consider GPS-enabled route maps, schedules, and user-defined preferences. An XR device may receive a user input or selection of an intended stop or destination within a mass transit system or car-for-hire destination either manually or via application integration. The system monitors the progress of the XR device location. As the mass transit vehicle, car-for-hire or other approaches the defined stop, the XR system initiates a multi-stage notification process, alerting the user of the approaching stop. This may include auditory or visual cues within the XR environment, haptic feedback, or other sensory signals, depending on the hardware and preferences configured. Should the XR user fail to acknowledge or respond to the initial notifications, the system may escalate the alert mechanism, for example temporarily shutting down or switching of the XR experience to a passthrough mode ensuring that the user is prepared to disembark the mass transit or for-hire vehicle at the appropriate time.

Additionally, this embodiment may include collaboration with the mass transit authorities, allowing for real-time updates and contingencies for unexpected delays, rerouting, or other disruptions to the planned route.

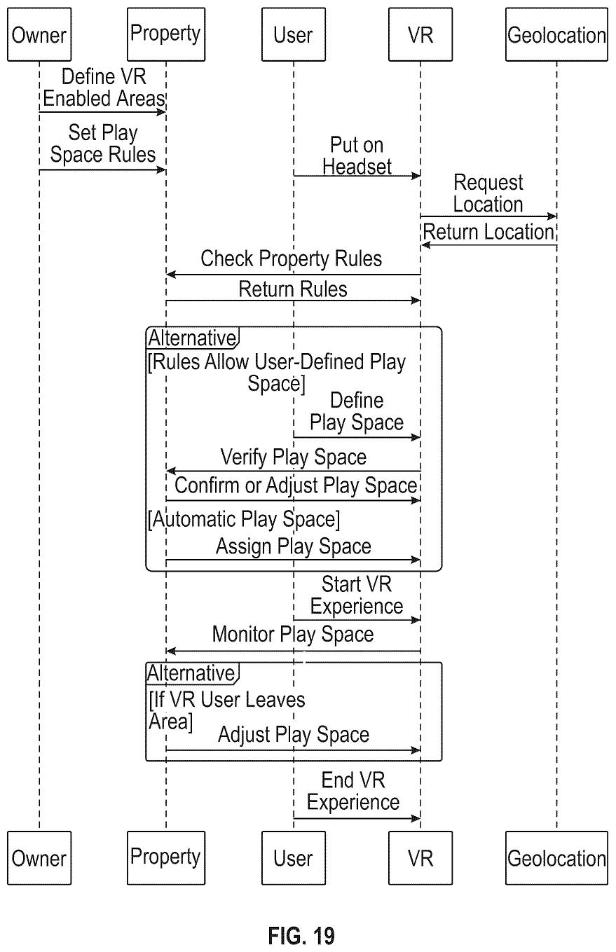

FIG. 19 illustrates an example of a sequence diagram defining geolocation policies for XR device usage, in accordance with some embodiments of the disclosure. For clarity purposes, the sequence diagram will be explained implementing a gym space model discussed further above in FIGS. 2-3.

In an embodiment, the XR administrator, such as a property owner, can define XR permitted and prohibited areas within their property and set permitted area rules, e.g., based on a predetermined or a dynamic schedule. An XR device user enters the gym location and puts on an XR device associated with their user account. In an embodiment, the user account is synced and connected, e.g., via the internet, to an XR system that authenticates user credentials, stores user and device preferences, and communicated with an XR administrator setting over a network connection. A location request is transmitted from the XR device, and a geolocation tag is received, e.g., from a location server over the internet or via a cellular connection. The XR device requests the XR policies for the gym location from the XR administrator, e.g., from a server storing the policies set by the XR administrator, and receives the policies relevant to that XR device. In an alternative embodiment, as shown in FIG. 19, the XR administrator may permit some or all XR device users to define their own permitted and prohibited areas, which can be submitted and synced with the XR administrator. The XR experience is initiated, e.g., via executing an XR program on the XR device. While the XR program is running, the location of the XR device within the physical space is monitored to ensure the XR devices remains in the permitted area. If the XR device is detected to approach or cross over a boundary between a permitted area and a prohibited area, a warning is presented on the XR device to guide the user to remain within the permitted area.

The above-described embodiments are intended to be examples only. Components or processes described as separate may be combined or combined in ways other than as described, and components or processes described as being together or as integrated may be provided separately. Steps or processes described as being performed in a particular order may be re-ordered or recombined.

Features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time.

It should also be noted that the systems and/or methods described above may be applied to, or used in accordance with, other systems and/or methods. In various embodiments, additional elements may be included, some elements may be removed, and/or elements may be arranged differently from what is shown. Alterations, modifications and variations can be affected to the particular embodiments by those of skill in the art without departing from the scope of the present application, which is defined solely by the claims appended hereto.

What is claimed is:

1. A method, comprising:
accessing first location information of a first specified area, wherein the first specified area is an area of physical space in which use of an extended reality (XR) device is permitted;
accessing second location information of a second specified area, wherein the second specified area is an area of physical space in which use of the XR device is prohibited;
determining whether an XR device is located within the first specified area;
in response to determining that the XR device is located within the first specified area, transmitting a first signal to the XR device indicating that a function of the XR device is permitted; and
in response to determining, at a later time, that the XR device is located within the second specified area, transmitting a second signal to the XR device indicating the function of the XR device is prohibited.

2. The method of claim 1, wherein the first location information and the second location information are previously defined and stored in a server, and where in the method further comprises:
accessing, via a network connection from the server, the first location and the second location information.

3. The method of claim 1, wherein determining that an XR device is located within the first specified area or the second specified area is based on geolocation information received from the XR device.

4. The method of claim 1, wherein determining that an XR device is located within the first specified area or the second specified area is based on image analysis using image information received from the XR device.

5. The method of claim 1, wherein the function of the XR device comprises execution of an application, and wherein the method further comprises:
determining an application type of the application; and
transmitting either the first signal or the second signal based on the determined application type.

6. The method of claim 5, wherein the first signal or the second signal is transmitted based on a set of predetermined rules defining at least one of a time period or a location in which an application type is permitted to be executed on the XR device.

7. The method of claim 1, further comprising:
determining a number of XR devices detected within the first specified area; and
dynamically updating at least one of a size and a shape of the first specified area based on the number of detected XR devices.

8. The method of claim 1, further comprising:
generating for display on the XR device a visual indicator, wherein the visual indicator comprises at least one of a message indicating prohibited use of the XR device in the second specified area and a graphical representation indicating a direction toward the first specified area.

9. The method of claim 1, further comprising:
generating for display on the XR device an indicator of boundaries of at least one of the first specified area and the second specified area.

10. The method of claim 1, further comprising:
accessing a location database comprising a dataset of information related to restricted locations where use of the XR device is prohibited; and
in response to determining that a current location of the XR device is a restricted location, causing to be displayed a pass-through image of a real environment of the XR device.

11. A system comprising:
control circuitry configured to:
access first location information of a first specified area, wherein the first specified area is an area of physical space in which use of an extended reality (XR) device is permitted;
access second location information of a second specified area, wherein the second specified area is an area of physical space in which use of the XR device is prohibited;
determine whether an XR device is located within the first specified area;
in response to determining that the XR device is located within the first specified area, transmit a first signal to the XR device indicating that a function of the XR device is permitted; and
in response to determining, at a later time, that the XR device is located within the second specified area, transmit a second signal to the XR device indicating the function of the XR device is prohibited.

12. The system of claim 11, wherein the first location information and the second location information are previously defined and stored in a server, and wherein the control circuitry is further configured to:
access, via a network connection from the server, the first location and the second location information.

13. The system of claim 11, wherein determining that an XR device is located within the first specified area or the second specified area is based on geolocation information received from the XR device.

14. The system of claim 11, wherein determining that an XR device is located within the first specified area or the second specified area is based on image analysis using image information received from the XR device.

15. The system of claim 11, wherein the function of the XR device comprises execution of an application, and wherein the control circuitry is further configured to:
determine an application type of the application; and
transmit either the first signal or the second signal based on the determined application type.

16. The system of claim 15, wherein the first signal or the second signal is transmitted based on a set of predetermined rules defining at least one of a time period or a location in which an application type is permitted to be executed on the XR device.

17. The system of claim 11, wherein the control circuitry is further configured to:
determine a number of XR devices detected within the first specified area; and
dynamically update at least one of a size and a shape of the first specified area based on the number of detected XR devices.

18. The system of claim 11, wherein the control circuitry is further configured to:
generate for display on the XR device a visual indicator, wherein the visual indicator comprises at least one of a message indicating prohibited use of the XR device in the second specified area and a graphical representation indicating a direction toward the first specified area.

19. The system of claim 11, wherein the control circuitry is further configured to:
generate for display on the XR device an indicator of boundaries of at least one of the first specified area and the second specified area.

20. The system of claim 11, wherein the control circuitry is further configured to:
access a location database comprising a dataset of information related to restricted locations where use of the XR device is prohibited; and
in response to determining that a current location of the XR device is a restricted location, cause to be displayed a pass-through image of a real environment of the XR device.
